(19) United States
(12) Patent Application Publication
(10) Pub. No.: US 2024/0184282 A1
(43) Pub. Date: Jun. 6, 2024

(54) PREDICTIVE MAINTENANCE OF INDUSTRIAL EQUIPMENT

(71) Applicant: Delaware Capital Formation, Inc., Wilmington, DE (US)

(72) Inventors: Bodhayan Dev, Sturbridge, MA (US); Atish P. Kamble, Acton, MA (US); Prem Swaroop, Lexington, MA (US); Vijay Karthick Baskar, Waltham, MA (US); Richard Buteau, Austin, TX (US); Sreedhar Patnala, Holliston, MA (US)

(21) Appl. No.: 18/285,449

(22) PCT Filed: Mar. 31, 2022
(86) PCT No.: PCT/US2022/022846

§ 371 Date: Oct. 3, 2023

Related U.S. Application Data
(63) Continuation-in-part of application No. 17/223,525, filed on Apr. 6, 2021.
(60) Provisional application No. 63/322,055, filed on Mar. 21, 2022.

(51) Int. Cl. G05B 23/02; F04C 14/28

(52) U.S. Cl. CPC G05B 23/0283; F04C 14/28; F04C 2270/12; F04C 2270/80

(57) ABSTRACT

Among other things, systems and techniques are described for predictive maintenance of industrial equipment. Sensor data is obtained, e.g., using sensor hubs that are configured to capture sensor data associated with one or more operating conditions of the industrial equipment. The sensor data is input to a trained machine learning model. The trained machine learning model includes a physics based feature extraction model and a deep learning based automatic feature extraction model. Operating conditions associated with operation of the industrial equipment are predicted using the trained machine learning models.

### CROSS REFERENCE TO RELATED APPLICATIONS

The present application is a continuation-in-part of U.S. patent application Ser. No. 17/223,525 filed on Apr. 6, 2021, entitled “Predictive Maintenance using Vibration Analysis of Vane Pumps,” which is herein incorporated by reference in its entirety. Additionally, the present application claims priority of U.S. Provisional Patent Application No. 63/322,055 filed on Mar. 21, 2022, entitled “End-to-End Wireless Sensor-Hub System,” which is herein incorporated by reference in its entirety.

### FIELD OF THE INVENTION

The present techniques relate to predictive maintenance of industrial equipment.

### BACKGROUND

Machinery refers to a driven mechanical structure that applies forces and controls movement to execute one or more actions. Generally, a machine converts power input to the machine into a specific application of output forces and movement. Machine elements include, for example, structural components, movement control components, and general control components. Structural components include frame members, bearings, axles, splines, vanes, shafts, fasteners, seals, and lubricants. Movement control components include gear trains, belt or chain drives, linkages, and cam and follower mechanisms. General control components include buttons, switches, indicators, logic, sensors, actuators and computer controllers.

Sensors can be used to capture data associated with industrial equipment. Industrial equipment includes machines used in manufacturing and fabrication. For example, industrial equipment includes but is not limited to pumps, heavy duty industrial tools, compressors, automated assembly equipment, and the like. Industrial equipment also includes machine parts and hardware, such as springs, nuts and bolts, screws, valves, pneumatic hoses, and the like.

### SUMMARY

In general, one or more aspects of the subject matter described in this specification can be embodied in one or more methods or systems. A method includes obtaining sensor data, wherein sensor hubs are configured to capture sensor data associated with one or more operating conditions of the industrial equipment. The method includes inputting sensor data to a trained machine learning model, wherein the trained machine learning model comprises a physics based feature extraction model and a deep learning based automatic feature extraction model. Additionally, the method includes predicting operating conditions associated with operation of the industrial equipment.

A system includes one or more sensor-hubs physically coupled with industrial equipment, the industrial equipment being at an operational site. Each of the one or more sensor-hubs includes a controller and one or more sensors. At least one sensor hub is located adjacent to a component of the industrial equipment that is a source of sensor data, and is configured to capture the sensor data associated with the industrial equipment. The system includes at least one processor at the operational site, the at least one processor being communicatively coupled with the sensor hubs via a network that provides integrated support for secure, wireless transmission of the sensor data at the operational site. The one or more sensor hubs are sequenced to transmit data across the network according to a current group number.

A method includes configuring sensor hubs in an order using a sequence established by a time of addition to a network. The method includes configuring the sensor hubs into one or more groups, wherein a number of sensor hubs in a respective group is calculated according to a maximum bandwidth consumed by a group of sensor hubs, wherein the maximum bandwidth does not exceed a data bandwidth of the network. Additionally, the method includes obtaining sensor data captured by the one or more groups according to a current group number, wherein the sensor data is obtained from each group of the one or more groups according to a predetermined schedule.

### BRIEF DESCRIPTION OF THE DRAWINGS

FIG. 1A is an illustration of a system configured to convert mechanical energy into fluid flow energy.

FIG. 1B is an illustration of a vane pump with a rotor in a first position.

FIG. 1C is an illustration of a vane pump with a rotor in a second position.

FIG. 1D is an illustration of a vane pump with a rotor in a third position.

FIG. 2 is a graph that illustrates flow rate as a function of differential pressure.

FIG. 3 is a block diagram of a physics-based model for predictive maintenance using vibration analysis of vane pumps.

FIG. 4 is a block diagram of a wavelet transforms in conjunction with a convolutional neural network for predictive maintenance using vibration analysis of vane pumps.

FIG. 5 is a block diagram of an LSTM-based model for predictive maintenance using vibration analysis of vane pumps.

FIG. 6 is a process flow diagram of a process that generates isolated pump vibration data.

FIG. 7 is a process flow diagram of a process that enables predictive maintenance using vibration analysis of vane pumps.

FIG. 8 is a block diagram of an example computer system.

FIG. 9A shows an example of a sensor hub.

FIG. 9B is a drawing of a sensor hub.

FIG. 10 is a block diagram of a sensor hub implementation.

FIG. 11A is a block diagram of an edge architecture that includes one or more sensor hubs.

FIG. 11B is drawing of a computer numerically controlled machine.

FIG. 11C is a drawing of an industrial machine.

FIG. 12 shows a process that enables an end-to-end wireless sensor-hub system.

FIG. 13 is a block diagram of a system that enables an end-to-end wireless sensor hub system.

FIG. 14 shows an end-to-end model training pipeline

FIG. 15 is a block diagram of a physics-based model for proactive prediction of operating conditions in industrial equipment.

FIG. 16 is a block diagram of a model for proactive prediction of operating conditions in industrial equipment.

FIG. 17 is a block diagram of a physics-based model for proactive prediction of operating conditions in industrial equipment.

FIG. 18 is a block diagram of a long short-term memory (LSTM) based model for proactive prediction of operating conditions in industrial equipment.

FIG. 19 shows a density plot.

FIG. 20 is a block diagram of an LSTM-auto encoder-based model for proactive prediction of operating conditions in industrial equipment.

FIG. 21 is a process flow diagram of a process that enables proactive prediction of anomalous conditions in industrial equipment.

### DETAILED DESCRIPTION

In the following description, for the purposes of explanation, numerous specific details are set forth in order to provide a thorough understanding of the present invention. It will be apparent, however, that the present invention can be practiced without these specific details. In other instances, well-known structures and devices are shown in block diagram form in order to avoid unnecessarily obscuring the present invention.

In the drawings, specific arrangements or orderings of schematic elements, such as those representing devices, modules, instruction blocks and data elements, are shown for ease of description. However, it should be understood by those skilled in the art that the specific ordering or arrangement of the schematic elements in the drawings is not meant to imply that a particular order or sequence of processing, or separation of processes, is required. Further, the inclusion of a schematic element in a drawing is not meant to imply that such element is required in all embodiments or that the features represented by such element may not be included in or combined with other elements in some embodiments.

Further, in the drawings, where connecting elements, such as solid or dashed lines or arrows, are used to illustrate a connection, relationship, or association between or among two or more other schematic elements, the absence of any such connecting elements is not meant to imply that no connection, relationship, or association can exist. In other words, some connections, relationships, or associations between elements are not shown in the drawings so as not to obscure the disclosure. In addition, for ease of illustration, a single connecting element is used to represent multiple connections, relationships or associations between elements. For example, where a connecting element represents a communication of signals, data, or instructions, it should be understood by those skilled in the art that such element represents one or multiple signal paths (e.g., a bus), as may be needed, to affect the communication.

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

Several features are described hereafter that can each be used independently of one another or with any combination of other features. However, any individual feature may not address any of the problems discussed above or might only address one of the problems discussed above. Some of the problems discussed above might not be fully addressed by any of the features described herein. Although headings are provided, information related to a particular heading, but not found in the section having that heading, may also be found elsewhere in this description. Embodiments are described herein according to the following outline:
1. General Overview
2. Vibration Data Generation
3. Physics-based Top Feature in Conjunction with Machine-Learning Based Classifier
4. Wavelet-transforms in conjunction with Convolutional Neural Network (CNN)
5. LTSM-Deep-Learning Architecture (Auto-Feature Extraction-Classification)
6. Predictive Maintenance Using Vibration Analysis of Vane Pumps
7. End-to-End Wireless Sensor-Hub System
8. Proactive Prediction of Operating Conditions in Industrial Equipment

### General Overview

Rotating machines (e.g., vane pumps, motors, fans, compressors, turbines) operate, in large part, due to the rotation of machine components. For example, vane pumps generally employ a number of vanes that travel along sliding and an out of a rotating rotor and making contact with the pump cavity. Vibrations produced by the rotating machinery are indicative of various operating conditions. These vibrations are measured using one or more sensors. The sensor data is pre-processed according to feature extraction system applied to the sensor data. The extracted features are classified to obtain a prediction of an operating condition of a rotating machine. In some cases, predictions from a plurality of feature extraction systems are determined and a final prediction is generated by combining the predictions from each individual feature extraction system.

To train the models employed by one or more feature extraction systems, the present techniques enable capture of isolated pump vibration data. In particular, the rotating machine is isolated, and components that are sources of vibration are eliminated. Vibration data associated with at least one predetermined operating condition of the rotating machine is generated, and the generated vibration data is a clean representation of rotating machine vibration under the operating condition, free from noise or vibrations that originate from sources other than the rotating machine.

Some of the advantages of these techniques include automated identification of operating conditions associated with rotating machinery. The present techniques eliminate reliance on a manual operator that could overlook or be unaware of dangerous operating conditions. Additionally, the present techniques enable efficient detection of poor operating conditions. Poor operating conditions can be damaging to industrial machinery. Further, broken down, out of operation machinery can cause significant delays further down in the production line, and could potentially be unsafe for operators. The present techniques reduce delays by preventing breakdowns associated with poor operating conditions. Moreover, the present techniques are able to recognize the fault modes in the received sensor data, even with the high-dimensional characteristics of the derived features.

### System Overview

As used herein, “sensor(s)” includes one or more hardware components that detect information about the environment surrounding the sensor. Some of the hardware components can include sensing components (e.g., vibration sensors, accelerometers), transmitting and/or receiving components (e.g., laser or radio frequency wave transmitters and receivers, transceivers, and the like), electronic components such as analog-to-digital converters, a data storage device (such as a RAM and/or a nonvolatile storage), software or firmware components and data processing components such as an ASIC (application-specific integrated circuit), a microprocessor and/or a microcontroller.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this description, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

The present techniques include various artificial intelligence (AI) models that are trained using data generated while one or more predetermined operating conditions exist. A number of constraints are applied to a setup of the rotating machine and other equipment used during to generate data. The trained models can subsequently be executed on data captured during real-time operation of a rotating machine. In some embodiments, the trained models output a prediction of one or more operating conditions currently affecting the rotating machine during operation of the rotating machine. In this manner, the present techniques identify operating conditions of the rotating machine without downtime.

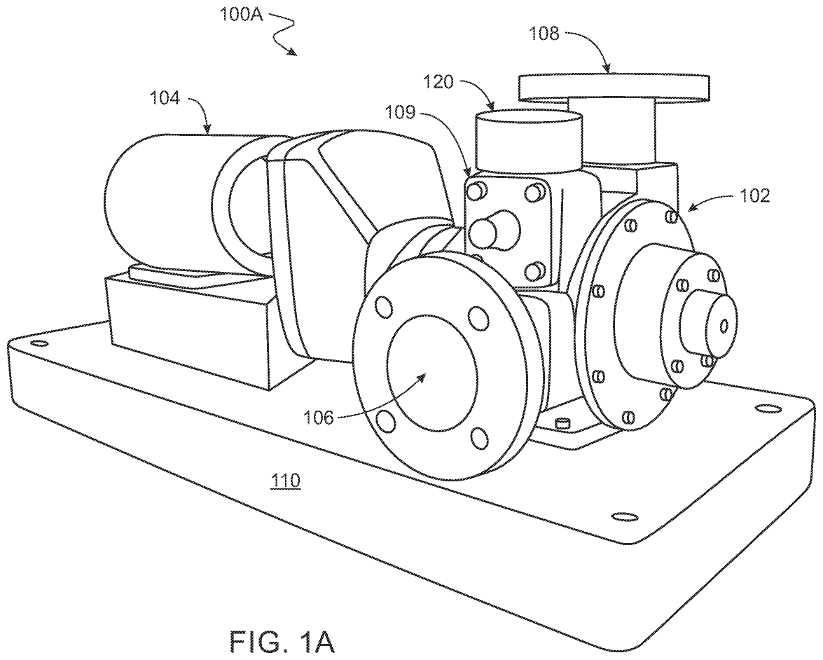

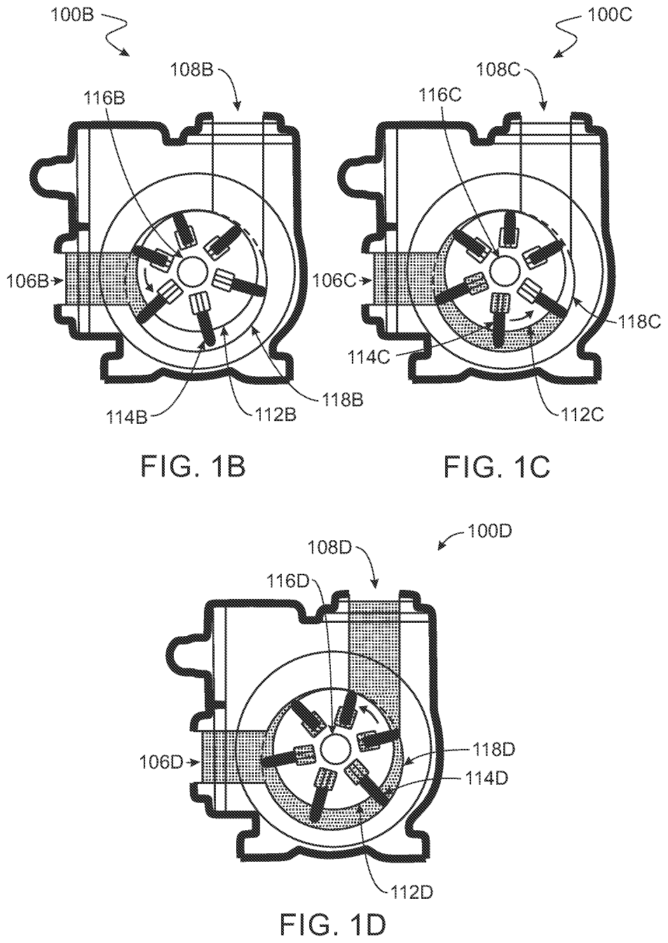

FIG. 1A is an illustration of a system 100A configured to convert mechanical energy into fluid flow energy. The system 100A includes a rotating machine 102. In the example of FIG. 1A, rotating machine 102 is a vane pump. For ease of description, the present techniques are described using a vane pump. However, the present techniques can be applied to any machinery that produces vibrations indicative of an operating condition.

Vane pumps are ubiquitous in industrial applications where fluid needs to be moved quickly from one place to another (e.g., loading and unloading transports, fueling equipment, chemical processing, refrigeration, liquid terminals, etc.). Vane pumps are continuously in operation in these industries under various conditions (e.g., chemical process, energy, transport military and marine, general industrial, oil and gas, etc.). Certain working conditions can be damaging to the pump. Additionally, a broken down, out of operation pump can cause significant delays further down in the production line, and could potentially be unsafe for operators.

The system 100A is a positive fluid displacement system. As illustrated, the rotating machine 102 is coupled with a motor 104. During operation, the motor 104 converts electrical energy to mechanical energy. The mechanical energy output by the motor 104 is used to drive rotations of a rotor within the rotating machine 102. In some embodiments, the motor is coupled with a rotor of the rotating machine 102 via a drive shaft (not illustrated).

Fluid enters the rotating machine 102 at the inlet 106, and fluid exits the rotating machine 102 at the outlet 108. Generally, internal components of the rotating machine 102 create a void at the inlet 106 draw fluid into the rotating machine 102. Fluid is transferred from the inlet 106 to discharge through the outlet 108 using the internal components. In some embodiments, the internal components of the rotating machine 102 force fluid out of the rotating machine. The rotating machine 102 includes a relief valve (RV) 109. In some embodiments, the RV 109 prevents the rotating machine 102 from creating a dangerous high-pressure situation.

In some embodiments, the present techniques include the training and execution of an AI model to identify operating conditions in real time for an operating rotating machine. For this purpose, the model analyzes vibrations of the rotating machine 102 as captured by a sensor 120. In some embodiments, the sensor is an accelerometer. Generally, an accelerometer converts mechanical forces that occur during a change in motion to an electrical current. In an example, the sensor 120 is a three-axis accelerometer. A three-axis accelerometer converts mechanical forces that occur during a change in motion along the axes to an electrical current. In some embodiments, a plurality of sensors are mounted in multiple locations on the rotating machine 102 to measure and record vibration data in real time. In some embodiments, the accelerometer is mounted atop of a relief valve.

In some embodiments, the rotating machine 102 and motor 104 are attached to a foundation 110. In some embodiments, the foundation 110 is an isolation block for employed during data generation. The isolation block isolates the rotating machine 102 and motor 104 from other components that can introduce vibrations during data generation. For ease of illustration, the foundation 110 is illustrated as being of a particular size relative to the rotating machine 102. However, the foundation 110 can be of any size. As used herein, isolation includes fixing the component to an independent foundation as compared to the foundation of the surrounding environment. For example, within a structure such as a building, factory, or test site, a portion of the foundation and flooring of the structure is removed and a separate foundation is built to form an isolation block. Accordingly, an isolation block is a separate structure erected directly on the earth. In addition to an isolation block, other vibration attenuation techniques or components may be used to isolate the rotating machine. For example, pipe supports, bearing supports, and other impact absorption features can be implemented.

The block diagram of FIG. 1A is not intended to indicate that the system 100A is to include all of the components shown in FIG. 1A. Rather, the system 100A can include fewer or additional components not illustrated in FIG. 1A (e.g., additional pumps, drive system components, tanks, piping, valves, heat exchangers, fluids, vanes, rotors, housings, inlets, cavities, outlets, isolation blocks, laser alignment equipment, vibration analyzers, data acquisition (DAQ) systems and the like. The system 100A may include any number of additional components not shown, depending on the details of the specific implementation. Furthermore, any of the models, sensors, vibration analyzers, and other described functionalities may be partially, or entirely, implemented in hardware and/or in a processor. For example, the functionality may be implemented with an application specific integrated circuit, in logic implemented in a processor, in logic implemented in a specialized graphics processing unit, or in any other device.

FIGS. 1B, 1C, and 1D are an illustration of vane pumps 100B, 100C, and 100D, respectively. In some embodiments, the vane pumps 100B, 100C, and 100D are rotating machines (e.g., rotating machine 102 of FIG. 1). In the example of FIG. 1B, a pump inlet 106B and pump outlet 108B are illustrated. The pump 100B includes a rotor 112B and vanes 114B driven by a shaft 116B within a pump cylinder 118B. Similarly, in the example of FIG. 1C, a pump inlet 106C and pump outlet 108C are illustrated. The pump 100C includes a rotor 112C and vanes 114C driven by a shaft 116C within a pump cylinder 118C. In the example of FIG. 1D, a pump inlet 106D and pump outlet 108D are illustrated. The pump 100D includes a rotor 112D and vanes 114D driven by a shaft 116D within a pump cylinder 118D. Accordingly, in the example of FIGS. 1B, 1C, and 1D, the interior of the vane pump is illustrated. Although not illustrated, during operation the vane pump is driven by a drive system including a motor (e.g., motor 104 of FIG. 1). Generally, the rotors 112B, 112C, and 112D are illustrated as circular with any number of slots. The rotor 112B, 112C, or 112D rotates within the pump cylinder 118B, 118C, 118D, driven by a motor coupled to a shaft 116B, 116C, 116D. As the rotor turns, vanes 114B, 114C, 114D (illustrated as solid black bars) move in and out of rotor slots.

FIG. 1B illustrates a rotor 112B as fluid enters the pump cylinder 118B, in a first position. FIG. 1C illustrates the rotor 112C as fluid fills the pump cylinder 118C, in a second position. FIG. 1D illustrates the rotor 112D in a third position as fluid fills the pump cylinder 118D and exits though the outlet 108D. In some embodiments, the centers of the pump cylinder 118 and the rotor 112 are offset, causing eccentricity. During operation, vanes slide into and out of the rotor slots and seal on all edges, creating chambers within the vane pump that fill with fluid pulled in by a vacuum at the respective inlet. In particular, when the pump shaft turns the rotor in the pump housing, centrifugal force, push rods, and pressurized fluid cause the vanes to move outward in their slots, and bear against the inner bore of the pump cylinder to form pumping chambers. The fluid is transferred within the pump housing to the outlet. At the outlet, the vane chambers decrease in volume, expelling fluid out of the pump. In some embodiments, each revolution displaces a constant volume of fluid. In some embodiments, a single pump is used to transfer fluid in an industrial application. In another embodiment, a plurality of pumps are used to coordinate the transfer of fluid. The present techniques apply to singular pumps as well as pumps operating in coordination.

The block diagrams of FIGS. 1B, 1C, and 1D are not intended to indicate that the vane pumps 100B, 100C, and 100D, respectively, are to include all of the components shown in FIGS. 1B, 1C, and 1D. Rather, the vane pumps 100B, 100C, and 100D can include fewer or additional components not illustrated in FIGS. 1B, 1C, and 1D (e.g., additional pumps, drive system components, tanks, piping, valves, heat exchangers, fluids, vanes, rotors, housings, inlets, cavities, outlets, isolation blocks, laser alignment equipment, vibration analyzers, DAQ systems and the like). The vane pumps 100B, 100C, and 100D may include any number of additional components not shown, depending on the details of the specific implementation.

### Vibration Data Generation

During operation, various operating conditions can be detrimental to a rotating machine (e.g., rotating machine 102 of FIG. 1A, vane pump 100B of FIG. 1B, vane pump 100C of FIG. 1C, vane pump 100D of FIG. 1D). As used herein, an operating condition is a phenomenon that is observed during some form of work or production (e.g., operation) by the rotating machine. An operating condition can include one or more levels or stages that indicate an increasing severity of the operating condition. In some embodiments, the operating condition is associated with circumstances that occur during operation of the rotating machine, such as a vane pump. The operating condition can result in mechanical damages to the vane pump or the mechanical assembly. Damages include mechanical seal failure, bushing failure, pitting, broken vanes, etc. Common operating conditions of vane pumps include normal, dry run, cavitation, misalignment, flow rate, proper engagement of the relief valve, aeration, fluid crystallization, vane wear, galled rotor, seizure damage, erosion, push rod wear or damage, unusual cylinder or liner wear, damage by large particles, bearing wear or damage, rotational bending fatigue, torsional fatigue, and the like. Although particular operating conditions are described herein, the present techniques are not limited to the presently described operating conditions. Rather, the operating conditions that are detected according to the present techniques include any conditions observable while the pump is operable (e.g., being driven or supplied power).

In an example, a normal operating condition represents a regular, natural, or desired standard of operation. During a normal operating condition, the pump provides fluid transfer functionality as expected according to the inputs to the pump. By contrast, during a dry run operating condition, the pump is operating (e.g., the rotor is being driven by a motor) without fluids. Operating a vane pump without fluids can damage the pump. During misalignment, the motor or gearbox shaft is not in alignment with the pump input shaft.

During cavitation, for example, fluid boils within the pump during operation. The boiling fluid is typically due to the presence of an inlet vacuum great enough that causes pressure to drop so that fluid boils at a temperature lower than expected at atmospheric pressure. For example, a strainer upstream of the pump can be clogged or otherwise blocked, thus choking the inlet flow and causing a vacuum at the inlet. The vacuum causes small gas bubbles to form within the fluid and these bubbles will soon after collapse/implode inside the pump causing damage. Evidence of cavitation includes, but is not limited to, excessive noise and vibration.

Some operating conditions are determined based upon, at least in part, combinations of other operating conditions. For example, flow rate is an operating condition that is dependent on other operating conditions, such as speed (e.g., rotations per minute (RPM) of the motor) and differential pressure at the pump. In some embodiments, higher speeds relate directly to higher flow rates. To set a predetermined flow rate for data generation, the operating conditions on which flow rate depends are plotted and trend lines used to determine the dependent operating condition.

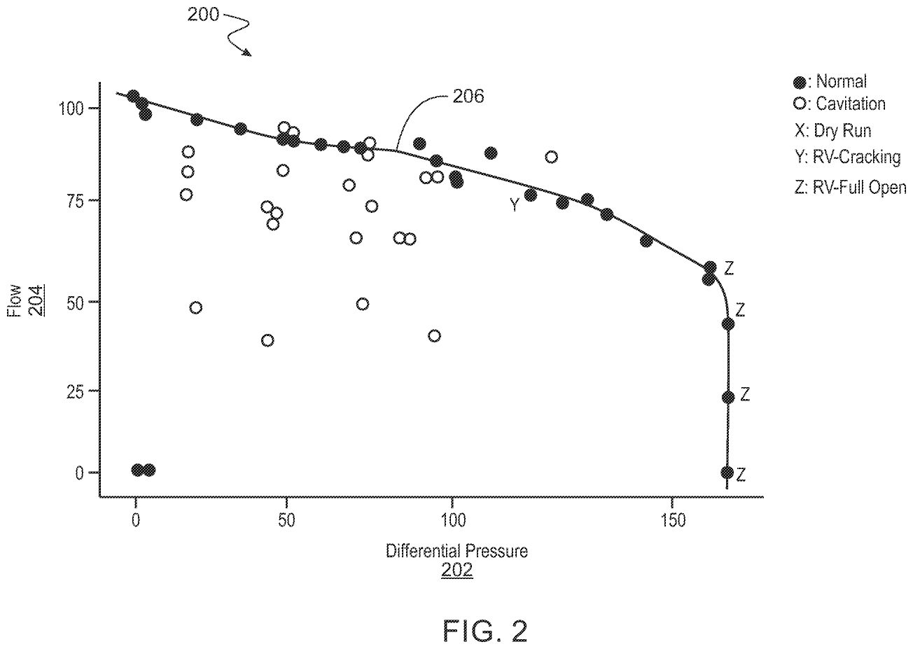

FIG. 2 is a graph 200 that illustrates flow rate as a function of differential pressure at a specific pump speed (RPM). In the graph 200, the flow rate 204 corresponds to the y-axis and differential pressure 202 corresponds to the x-axis. As illustrated on the graph 200, normal operating conditions, cavitation, dry run, relief valve cracking, and relief valve full open operating conditions are plotted. In some embodiments, relief valve cracking refers to the initial opening of the relief valve, and relief value full open refers to when the valve is fully open. The relief valve is active after a relief valve cracking event occurs. Initially, when the relief valve “cracks” open, there is generally a smaller area available for relief (e.g., fluid transfer) when compared to the fully open relief valve. Generally, when the relief valve is active, some fluid exits the pump via the relief valve. While particular operating conditions are plotted on the graph 200, any operating conditions may be used.

A trend line 206 is overlaid on the graph 200 generally connecting the data points that represent normal operating conditions. The trend line 206 corresponds to a particular RPM. In an example, if the rotations per minute (RPM) and differential pressure are known, the flow rate can be determined by locating known values on the graph 200. In some embodiments, graph generation includes overlaying trend lines that connect normal operating conditions of the pump. For ease of illustration, a single RPM trend line is illustrated. However, multiple trend lines may be represented on the graph 200. In some embodiments, the graph 200 is created using vibration data generated under one or more predetermined operating conditions as described below. In real world vane pump operation, flow rates can be determined by locating the flow rate on the generated graph 200 using RPM (which is typically known or set) and differential pressure (which can be observed using a pressure meter). Thus, the present techniques enable a determination of flow rate without a flowmeter or other flow measurements.

Vibration data is generated while one or more operating conditions are applied to the operation of the pump. In some embodiments, a controller or processor is used to adjust control values, speed/RPM, or other variables to simulate one or more operating conditions. Predetermined operating conditions can be simulated by adjusting one or more components of a system under test, such as the motor, control valves, or pressures. Vibrations are measured or captured during data generation. In some embodiments, a vibration analyzer is used to process data captured by the sensor. For example, the vibration analyzer executes a time series analysis on the captured vibration data. Additionally, a data acquisition system (DAQ) is implemented to record system parameters such as speed, pressure, temperature, etc. In some embodiments, speed, power, and torque are measured via data acquisition device in the shaft system of the vane pump. In some embodiments, differential pressure is monitored and adjusted using control valves.

In some embodiments, one or more three axis accelerometers (e.g., sensor 120 of FIG. 1A) are coupled with the vane pump. In some embodiments, the accelerometer captures data associated with vibrations caused by the pump. The vibration data captured is isolated pump vibration data associated with the one or more predetermined operating conditions. As used herein, isolated pump vibration data is raw accelerometer data representative of vibrations generated by a vane pump, without noise or vibrations from other sources. Isolated pump vibration data is generated under one or more constraints. The constraints include, for example, such as an isolation block, a laser aligned setup, and a variable frequency driven (VFD) motor. As a result, isolated pump vibration data is a clean representation of rotating machine vibration under the operating condition, free from noise or vibrations that originate from sources other than the rotating machine (e.g., gearbox).

For example, equipment used to develop the isolated vane pump vibration data includes an isolation block (e.g., foundation 110 of FIG. 1) to prevent exterior vibrations from interfering with testing. In an example, the isolation block is a large foundation that is independent of the building foundation. This foundation has a large mass of its own and is not directly connected to the foundation of the building. Accordingly, the foundation can dampen any vibration that might originate from the factory floor, highway, across the street, and the like. In an example, the motor and the pump are directly coupled with the isolation block. In some embodiments, a gearbox is not present in the system used for data generation. By eliminating gearboxes, the chance of generating any tooth-mesh or bearing frequencies from the gearbox when generating isolated pump vibration data is eliminated. Other equipment associated with operating the vane pump, such as a drive shaft system, tanks, piping, valves, heat exchangers, and test fluid are used to complete the system for testing. The other equipment may be coupled with the vane pump and motor using flexible piping and couplings to reduce any vibrations from the other equipment. In some embodiments, the vane pump is mounted on an independent base bolted to isolation block.

Laser alignment equipment is used to verify, measure, and define one or more levels of misalignment. In some embodiments, multiple levels of misalignment determined. The levels of alignment can include, for example, near-perfection (e.g., aligned), within approved limits (e.g., slightly aligned, slightly misaligned, within a predetermined range or threshold), and not aligned (e.g., misaligned, heavily misaligned). In some embodiments, one or more levels of alignment are tested with the presence of any combination of other operating conditions, such as normal, dry run, cavitation, flow rate, proper engagement of the relief valve, aeration, fluid crystallization, vane wear, galled rotor, seizure damage, erosion, push rod wear or damage, unusual cylinder or liner wear, damage by large particles, bearing wear or damage, rotational bending fatigue, torsional fatigue, and the like. Isolated pump vibration data is generated with a large number of test runs with various permutations of the operating conditions.

The motor provides further constraints when generating isolated pump vibration data. In some embodiments, the motor (e.g., motor 104 of FIG. 1) used to drive the vane pump is a direct drive high power electric motor with variable frequency drive (VFD) control. For the purposes of data generation, a greatly overpowered (for a standard application) motor is used and then driven at lower power frequencies to achieve a range of speeds. The motor is run at lower speeds during data generation, enabling electrical reduction (VFD) of RPMs instead of a mechanical reduction (gearbox). In this manner, any vibrations due to mechanical reductions in speed are eliminated. Thus, testing can be performed at multiple speeds, and the use of a gearbox is eliminated, as a gearbox can introduce additional vibrations that can add noise to or otherwise corrupt the isolated pump vibration data. Traditional vibration based fault diagnostic methods are limited to a constant speed and load.

To accurately characterize the vibrations generated under one or more predetermined operating conditions, a high number of tests are executed on a vane pump with constraints as described above. During each test, one or more predetermined operating conditions are replicated and isolated pump vibration data is generated as the vane pump operates. One or more accelerometers coupled with the vane pump captures the isolated pump vibration data. In an example, 1,269 runs of a test pump are executed to isolate the effects of predetermined operating conditions. Accordingly, the present techniques generate isolated pump vibration data by executing a large number of runs on a constrained vane pump. During isolated pump vibration data generation, the vibration data is logged at a high rate for a set period of time to enable a significant data population size. In some embodiments, the isolated pump vibration data along with the one or more predetermined operating conditions are used to train one or more models that enable predictive maintenance using vibration analysis of vane pumps. Additionally, in some embodiments real-world vibration data associated with the predetermined operating conditions is obtained and used to refine the isolated pump vibration data captured under the constraints using real-world vibration data. For example, real world data is obtained though beta testing.

Physics-Based Top Feature in Conjunction with Machine-Learning Based Classifier

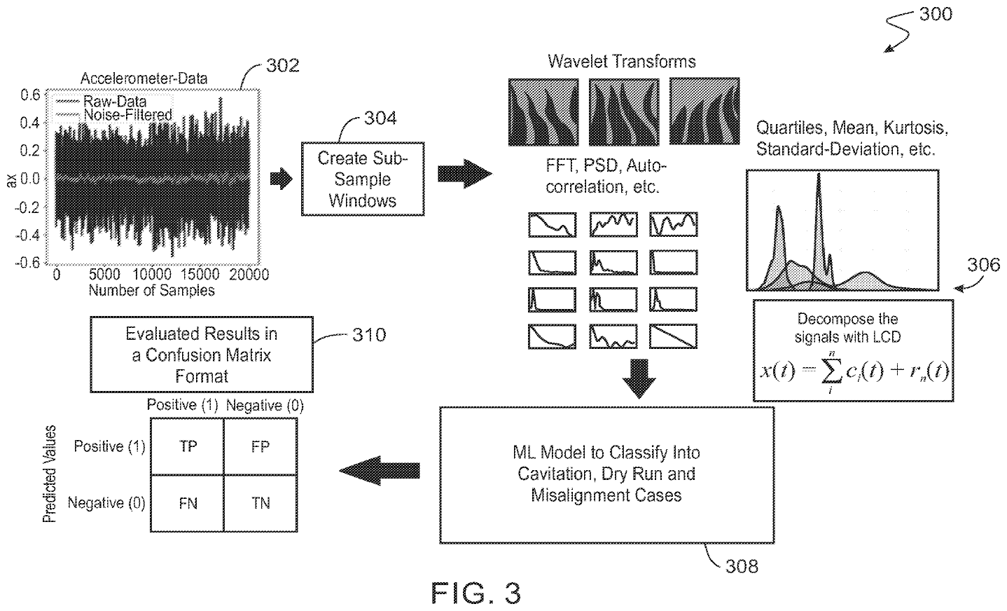

FIG. 3 is a block diagram of a physics-based model 300 for predictive maintenance using vibration analysis of vane pumps. FIG. 3 includes vibration data 302. In an example, vibration data 302 is captured during operation of a rotating machine (e.g., rotating machine 102 of FIG. 1, vane pump 100B of FIG. 1C, vane pump 100C of FIG. 1C). The rotating machine may be, for example, a vane pump. The vibration data 302 may be captured by one or more sensors (e.g., sensor 120 of FIG. 1). At block 304, subsample windows are created from the captured vibration data 302. In some embodiments, subsample windows include measurements captured at regular time intervals. In some embodiments, subsample windows include measurements captured at irregular time intervals. Additionally, at block 304 the data may be further preprocessed according to the particular feature extraction system. Generally, the preprocessing as described herein modifies the vibration data so that it can be processed by the corresponding feature extraction system. For example, pre-processing converts the sensor data from a raw format to an other format. In some embodiments, the preprocessing can vary according to the particulars of the feature extraction system used.

At reference number 306, a plurality of feature extraction systems is illustrated. As used herein, a feature extraction system is one or more processes, techniques, or components used to characterize data input to the feature extraction system. In the example of FIG. 3, feature extraction systems include wavelet transforms, statistical feature extraction (e.g., quartiles, mean, kurtosis, standard deviation, etc.), and time series feature extraction (e.g., fast Fourier transform (FFT), power spectral density (PSD), auto-correlation, etc.). In some embodiments, the feature extraction system outputs a feature vector. In some embodiments, a dimensionality of the output of feature extraction system at reference number 306 is reduced using principal component analysis (PCA). For example, PCA reduces the dimensionality of the output by projecting each data point onto a first few principal components to obtain lower dimensional data while preserving as much of the data's variation as possible. Additionally, in some embodiments, t-distributed stochastic neighbor embedding (t-SNE), Principal Component Analysis and Linear Discriminant Analysis are introduced to reduce the dimensionality of the feature vectors.

At block 308, the output of the one or more feature extraction systems is obtained by a machine learning (ML) model. The machine learning model predicts one or more operating conditions by classifying the data output by the feature extraction system into the one or more operating conditions. In an example, the machine learning model is a decision-tree-based ensemble machine learning algorithm that uses a gradient boosting framework (e.g., XGBoost). In an example, the machine learning model is a supervised learning algorithm consisting of a number of decision trees that are averaged (e.g., Random Forest). Additionally, in an example, the machine learning model as described herein is linear algorithm based on a cost function defined as a sigmoid function (e.g., logistic regression).

Accordingly, the at least one operating condition is identified by a likelihood operating condition exists based on the sensor data. In an example, the machine learning based classifier uses training data (e.g., isolated pump vibration data) to determine how the extracted features relate to one or more operating conditions. In the example of FIG. 3, the one or more operating conditions are cavitation, dry run, and misalignment. However, a machine learning model according to the present techniques can classify data output by a feature extraction system into any operating condition where the machine learning model was trained using isolated pump vibration data associated with the operating condition. At block 310, the performance of the machine learning model in predicting the one or more operating conditions is evaluated in a confusion matrix format. In some embodiments, evaluation of the classification in a confusion matrix format enables visualization of the performance of the classifier.

Accordingly, FIG. 3 classifies real time data output by a rotating machine into one or more operating conditions using models trained with isolated pump vibration data. In some embodiments, vibration data from a vane pump operating at a client site, under real world operating conditions is captured. For example, real world vibration data is from vane pumps that are continuously in operation in a variety of industries, such as chemical process, energy, transport, military and marine, general industrial, oil and gas, etc. The vibration data captured during real world operation (e.g., vibration data 302) of a vane pump is sampled. In particular, the real world vibration data is divided into subsample windows.

Generally, the feature extraction system decomposes the vibration data into a feature space. A feature is information regarding properties of the vibration data. For example, a feature is a particular characteristic in the data that is extracted using time domain techniques, frequency domain techniques, or any combination thereof. In an example, a feature extraction system applied to the vibration data is a wavelet transform. A wavelet transform is a mathematical function used to divide a given function or continuous time signal into different scale components. The wavelet transform provides frequency information with the corresponding temporal data. In some embodiments, a wavelet transform decomposes the input into wavelets of various scales in the time domain. Pre-processing data when the feature extraction system is a wavelet transform includes applying a low pass filter to raw accelerometer data to denoise the raw data. The wavelet transform is applied to the filtered data, and the resulting wavelets have variable window sizes and provide a local structure of the data in a time-frequency domain. In an example, raw accelerometer data is captured and pre-processed to raw filtered data that is reshaped into small packets of 100 subsamples, 60% training, 20% validation, and 20% test. The accelerometer data is transformed into wavelets. The wavelets may be a 128×128 resolution on scale. Wavelet transforms can be used effectively for transient feature extraction and extract signal features over the entire spectrum without a dominant frequency band. In some embodiments, the dimensionality of features extracted using wavelet transform based feature extraction is reduced via principal component analysis to transform the original extracted features into a new set of uncorrelated features. For normal, dry run, and cavitation, the wavelet patterns produced by the wavelet transforms are visually different. These distinct patterns are learned by the model during training. In some embodiments, the results according to the present techniques may be output via a confusion matrix.

In an example, a feature extraction system applied to the vibration data is a frequency domain analysis. Generally, the frequency domain analysis includes a fast Fourier transform (FFT), power spectral density (PSD), auto-correlation, and the like. The FFT translates the vibration data from the time domain into the frequency domain and features are extracted. The power spectral density of the vibration data can also be computed, and features extracted from the power spectral density. Generally, autocorrelation is the correlation of a signal with the delayed copy of itself. Features are extracted from the correlation are input to a machine learning based classifier. Pre-processing data when the feature extraction system is a frequency domain analysis includes applying a low pass filter to raw accelerometer data to denoise the raw data.

In this example, features are extracted as peak amplitudes on a chart charting against time lag in seconds. In some embodiments, for a subsample window of vibration data, the FFT, power spectral density, and autocorrelation are plotted. The peaks of each algorithm (FFT, power spectral density, and autocorrelation) are distinct and different for each of the conditions. In some embodiments, the machine learning algorithm distinguishes between conditions based on the peak of the respective frequency domain analysis plots. In another example, a feature extraction system applied to the vibration data is a statistical time domain feature extraction system. In this example, statistical time domain features include quartiles, mean, kurtosis, standard deviation, and the like.

In some embodiments, local characteristic decomposition (LCD) is used to transform the raw signals into a number of intrinsic scaled components (ISC). In the subsequent steps, any feature extraction system is applied to the ISC (e.g., FFT, wavelet transformations, kurtosis, mean, median etc.). For each feature extracted using post LCD-ISC (e.g., high dimensional features), dimensional reduction techniques like t-distributed stochastic neighbor embedding (t-SNE) or principal component analysis (PCA) are implemented. These reduced dimensional features can then be input into a machine learning based classifier for classifying into different pump conditions.

The block diagram of FIG. 3 is not intended to indicate that the model 300 is to include all of the components shown in FIG. 3. Rather, the model 300 can include fewer or additional components not illustrated in FIG. 3 (e.g., additional pre-processing, frequency domain analysis, time series feature extraction, statistical based feature extraction, machine learning models, confusion matrices, etc.) The model 300 may include any number of additional components not shown, depending on the details of the specific implementation. Furthermore, any of the described functionalities may be partially, or entirely, implemented in hardware and/or in a processor. For example, the functionality may be implemented with an application specific integrated circuit, in logic implemented in a processor, in logic implemented in a specialized graphics processing unit, or in any other device.

Wavelet-Transforms in Conjunction with Convolutional Neural Network (CNN)

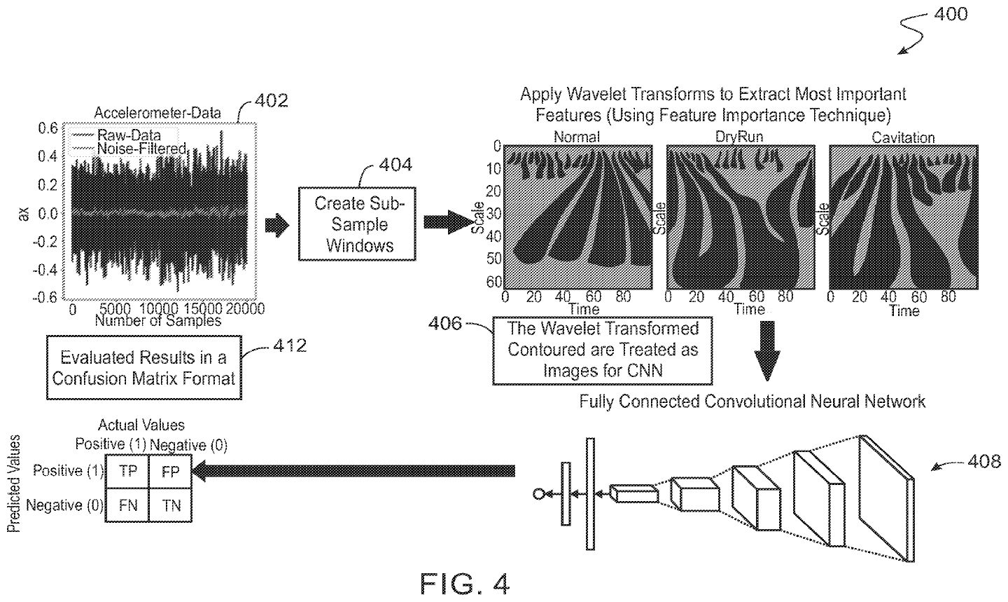

FIG. 4 is a block diagram of a wavelet transforms in conjunction with a convolutional neural network. Similar to FIG. 3, FIG. 4 includes vibration data 402. The vibration data 402 may be captured by one or more sensors (e.g., sensor 120 of FIG. 1). At block 404, subsample windows are created from the captured vibration data 402. In some embodiments, subsample windows include measurements captured at regular time intervals. In some embodiments, subsample windows include measurements captured at irregular time intervals. Additionally, at block 404 the data may be further preprocessed according to the particular feature extraction system. Generally, the preprocessing as described herein modifies the vibration data so that it can be processed by the corresponding feature extraction system. In some embodiments, the preprocessing can vary according to the particulars of the feature extraction system used.

At reference number 406, wavelet transforms are illustrated. In the example of FIG. 4, the wavelet transforms are determined using a feature importance technique. In particular, a threshold is applied to the wavelet transform to determine the most important features. As used herein, the most important features are those features that are above a predetermined threshold. In an example, raw accelerometer data is captured and pre-processed to raw filtered data that is reshaped into small packets of 100 subsamples, including training, validation, and testing packets. The wavelet transforms are ranked and input to a fully connected a convolutional neural network (CNN) 408. In some embodiments, the wavelet transforms are processed by the fully connected convolutional neural network as images. Accordingly, the CNN 408 may be a wavelet-based CNN. In some embodiments, the CNN includes several layers, including convolutional layers, subsampling layers, and fully connected layers. In the example of FIG. 4, wavelets were used as they have very distinct patterns and can be treated as images. The CNN 408 classifies the data output by the feature extraction system into one or more operating conditions. In the example of FIG. 4, the one or more operating conditions are cavitation, dry run, and misalignment. However, a machine learning model according to the present techniques can classify data output by a feature extraction system into any operating condition where the machine learning model was trained using isolated pump vibration data associated with the operating condition.

At block 412, the performance of the machine learning model in predicting the one or more operating conditions is evaluated in a confusion matrix format. In some embodiments, evaluation of the classification in a confusion matrix format enables visualization of the performance of the classifier.

The block diagram of FIG. 4 is not intended to indicate that the model 400 is to include all of the components shown in FIG. 4. Rather, the model 400 can include fewer or additional components not illustrated in FIG. 4 (e.g., additional pre-processing, wavelet transforms, CNNs, machine learning models, confusion matrices, etc.) The model 400 may include any number of additional components not shown, depending on the details of the specific implementation. Furthermore, any of the described functionalities may be partially, or entirely, implemented in hardware and/or in a processor. For example, the functionality may be implemented with an application specific integrated circuit, in logic implemented in a processor, in logic implemented in a specialized graphics processing unit, or in any other device.

### LTSM-Deep-Learning Architecture (Auto-Feature Extraction-Classification)

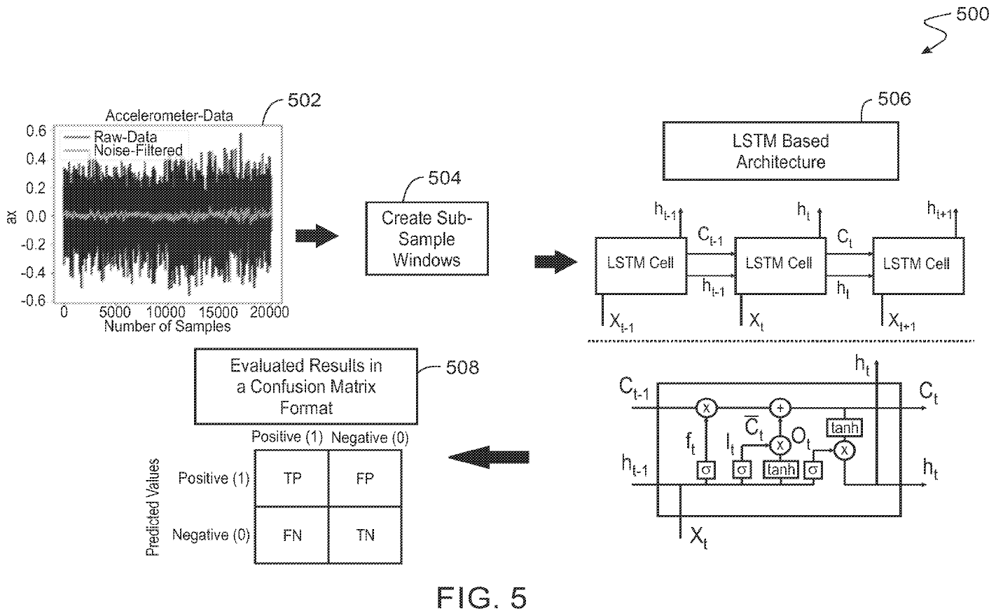

FIG. 5 is a block diagram of an LSTM-based model. Similar to FIG. 3, FIG. 5 includes vibration data 502. The vibration data 502 may be captured by one or more sensors (e.g., sensor 120 of FIG. 1). At block 504, subsample windows are created from the captured vibration data 502. In some embodiments, subsample windows include measurements captured at regular time intervals. In some embodiments, subsample windows include measurements captured at irregular time intervals. Additionally, at block 504 the data may be further preprocessed according to the particular feature extraction system. Generally, the preprocessing as described herein modifies the vibration data so that it can be processed by the corresponding feature extraction system. In some embodiments, the preprocessing can vary according to the particulars of the feature extraction system used.

At reference number 506, a long short-term memory (LSTM) based architecture is illustrated. The LSTM processes a plurality of parallel sequences of vibration data. For example, a three axis accelerometer captures data that is associated with vibrations along the x, y, and z axes. Using an LSTM based architecture, the raw vibration data is filtered to remove noise. The LSTM then extracts features from the filtered signals and classifies the features into one or more operating conditions. In some embodiments, creating subsample windows of the raw vibration data for input into an LSTM based architecture includes partitioning the data into multiple overlapping windows. In some embodiments, the input data is classified into one or more operating conditions by using the prediction from the last time step as the classification head of the neural network. The LSTM based architecture as described herein implements a gate-based network (e.g., LTSM, Recurrent Neural Network, Gated Recurrent Units, etc.) to classify the vibration data into an operating condition without separate feature extraction for classification.

At block 508, the performance of the machine learning model in predicting the one or more operating conditions is evaluated in a confusion matrix format. In some embodiments, evaluation of the classification in a confusion matrix format enables visualization of the performance of the classifier.

The block diagram of FIG. 5 is not intended to indicate that the model 500 is to include all of the components shown in FIG. 5. Rather, the model 500 can include fewer or additional components not illustrated in FIG. 5 (e.g., additional pre-processing, LTSM architectures, machine learning models, confusion matrices, etc.) The model 500 may include any number of additional components not shown, depending on the details of the specific implementation. Furthermore, any of the described functionalities may be partially, or entirely, implemented in hardware and/or in a processor. For example, the functionality may be implemented with an application specific integrated circuit, in logic implemented in a processor, in logic implemented in a specialized graphics processing unit, or in any other device.

### Predictive Maintenance Using Vibration Analysis of Vane Pumps

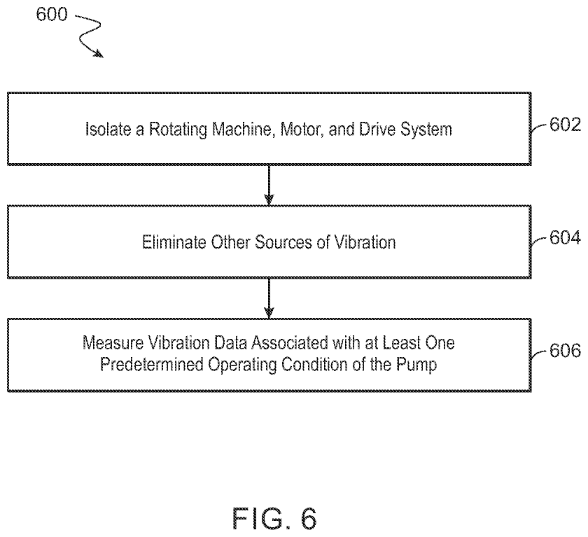

FIG. 6 is a process flow diagram of a process 600 that generates isolated pump vibration data. The example process 600 can be implemented by the system 100A of FIG. 1A and used to generate the isolated pump vibration data that is used to train the model 300 of FIG. 3, the model 400 of FIG. 4, or the model 500 of FIG. 5. In various examples, the process 600 may be implemented using the processor of the computer system 800.

At block 602 a rotating machine (e.g., rotating machine 102 of FIG. 1), motor (e.g., motor 104 of FIG. 1), and drive system are isolated. In some embodiments, the rotating machine, motor, and drive system are isolated by coupling the rotating machine, motor, and drive system to an isolation block (e.g., isolation block 110 of FIG. 1). Isolating the rotating machine, motor, and drive system includes separating the rotating machine, motor and drive system such that vibrations external to the rotating machine, motor, and drive system are eliminated. For example, the rotating machine, motor, and drive system are physically isolated from other equipment associated with operating the rotating machine, such as tanks, piping, valves, heat exchangers, and test fluid.

At block 604, other sources of vibration are eliminated. For example, the other equipment associated with operating the rotating machine (and necessary to generate one or more predetermined operating conditions) are coupled with the rotating machine, motor, and drive system to generate vibration data. In some embodiments, the other equipment is mounted to other isolation blocks. In some embodiments, the other equipment is connected to the rotating machine, motor, and drive system using flexible piping to reduce any vibrations from the other equipment. At block 606, vibration data associated with one or more predetermined operating conditions of the pump is measured. In some embodiments, the measured vibration data is isolated pump vibration data from the rotating machine. The isolated pump vibration data does not include noise from other sources of vibration, as the other sources of vibration are eliminated through strategic equipment placement, usage of isolation blocks, usage of flexible or vibration absorbing piping, and other vibration attenuation techniques.

The process flow diagram of FIG. 6 is not intended to indicate that the blocks of the example process 600 are to be executed in any order, or that all of the blocks are to be included in every case. Further, any number of additional blocks not shown may be included within the example process 600, depending on the details of the specific implementation.

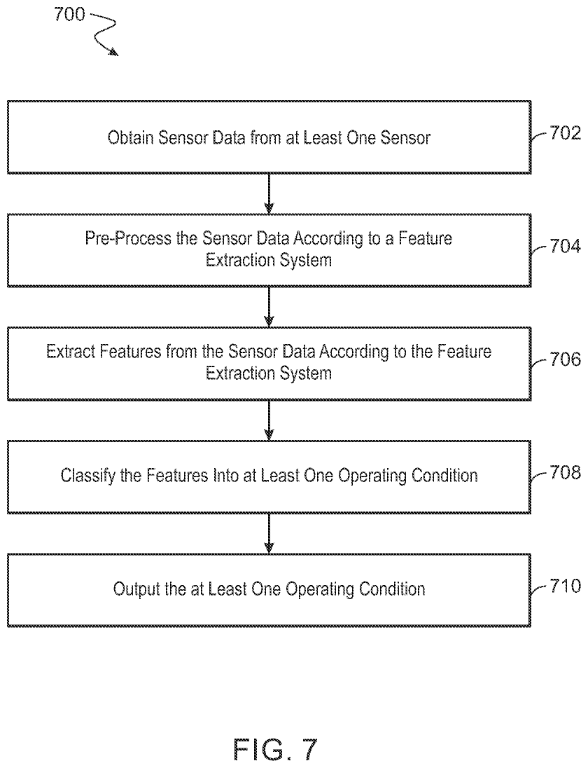

FIG. 7 is a process flow diagram of a process 700 that enables predictive maintenance using vibration analysis of vane pumps. The example process 700 can be implemented by trained models, such as the model 300 of FIG. 3, the model 400 of FIG. 4, or the model 500 of FIG. 5. In various examples, the process 700 may be implemented using trained models executing on the processor of the computer system 800.

At block 702, sensor data (e.g., vibration data 302 of FIG. 3, vibration data 402 of FIG. 4, vibration data 502 of FIG. 5) is obtained from at least one sensor (e.g., sensor 120). In some embodiments, the sensor is an accelerometer. At block 704, the sensor data is preprocessed according to a feature extraction system (e.g., reference number 306 of FIG. 3, reference number 406 of FIG. 4, reference number 506 of FIG. 5). For example, the sensor data may be used to create subsample windows (e.g., block 304 of FIG. 3, block 404 of FIG. 4, and block 504 of FIG. 5). In some embodiments, the subsample windows include measurements captured at regular time intervals. In some embodiments, subsample windows include measurements captured at irregular time intervals.

At block 706, features are extracted from the sensor data according to the feature extraction system. For example, wavelet transform features are extracted from wavelet transforms. FFT features are extracted from and FFT transform. In some embodiments, the dimensionality of the extracted features is reduced. At block 708, the features are classified into at least one operating condition. For example, operating conditions include normal, dry run, cavitation, misalignment, flow rate, proper engagement of the relief valve, aeration, fluid crystallization, vane wear, galled rotor, seizure damage, erosion, push rod wear or damage, unusual cylinder or liner wear, damage by large particles, bearing wear or damage, rotational bending fatigue, torsional fatigue, and the like. In some embodiments, the models are stress tested by running multiple error conditions at once such as dry run and misalignment. Additionally, in some embodiments, a plurality of feature extraction systems are used to extract a respective plurality of feature sets. One or more classifiers are used to classify the feature sets into respective operating condition classifications. The respective operating condition classifications are combined into a final prediction.

At block 710, the at least one operating condition is output. In some embodiments, a representation of the at least one operating condition is rendered at a device. The representation informs a user of a status of the vane pump. In an example, the user is a technician monitoring the operation of the vane pump. Analyzing accelerometer data to determine operating conditions of a vane pump cannot be directly executed by humans. Accordingly, the operating condition is output in a human observable form. As used herein, a human observable form may refer to a form that is understood by humans. For example, audio may be output that indicates an operating condition. The output may be an electronic assistant announcing the operating condition. The output may be a series of chirps, alerts, or other auditory warnings that a dangerous operating condition is occurring. A human observable form may also be visual. For example, text may be rendered or displayed that indicates an operating condition. The visual output may also be changes in lighting, blinking, or other alerts regarding one or more operating conditions.

The process flow diagram of FIG. 7 is not intended to indicate that the blocks of the example process 700 are to be executed in any order, or that all of the blocks are to be included in every case. Further, any number of additional blocks not shown may be included within the example process 700, depending on the details of the specific implementation.

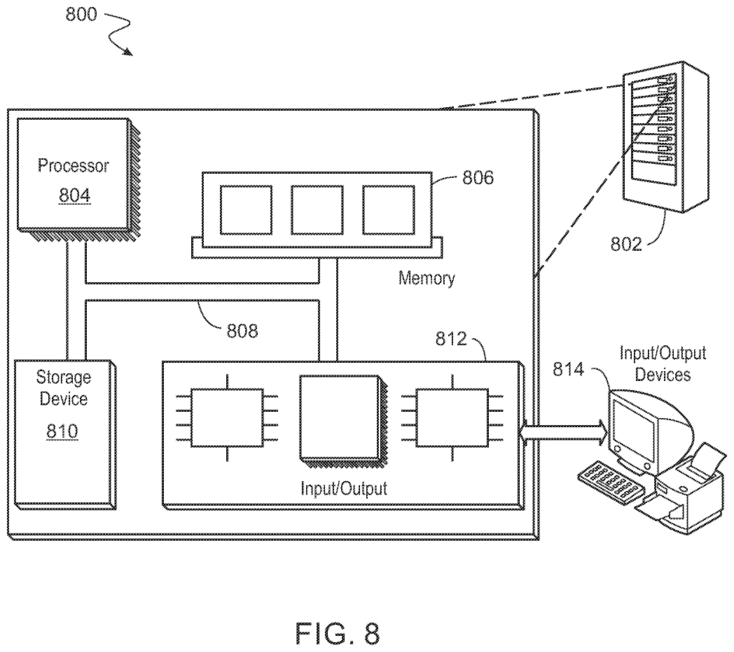

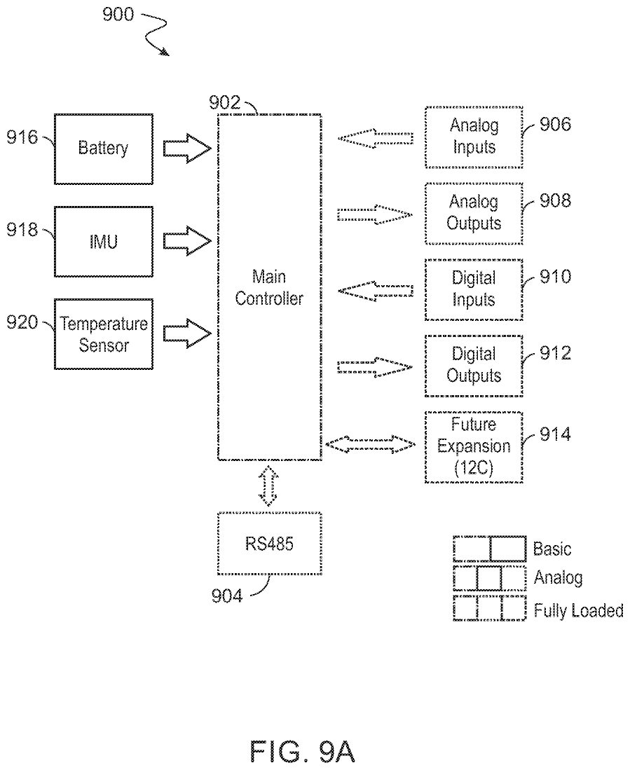

FIG. 8 is a block diagram of an example computer system 800. For example, system 100A of FIG. 1, the model 300 of FIG. 3, model 400 of FIG. 4, or the model 500 of FIG. 5 could be a part of an example of the system 800 described here. The system 800 includes a processor 804, a memory 806, a storage device 810, and one or more input/output device interfaces 812. Each of the components 804, 806, 810, and 812 can be interconnected, for example, using a system bus 808.

The processor 804 is capable of processing instructions for execution within the system 800. The term “execution” as used here refers to a technique in which program code causes a processor to carry out one or more processor instructions. The processor 804 is capable of processing instructions stored in the memory 806 or on the storage device 810. The processor 804 may execute operations such as isolated pump vibration data generation and predictive maintenance using vibration analysis of vane pumps. The memory 806 stores information within the system 800. In some implementations, the memory 806 is a computer-readable medium. In some implementations, the memory 806 is a volatile memory unit. In some implementations, the memory 806 is a non-volatile memory unit.

The storage device 810 is capable of providing mass storage for the system 800. In some implementations, the storage device 810 is a non-transitory computer-readable medium. In various different implementations, the storage device 810 can include, for example, a hard disk device, an optical disk device, a solid-state drive, a flash drive, magnetic tape, or some other large capacity storage device. In some implementations, the storage device 810 may be a cloud storage device, e.g., a logical storage device including one or more physical storage devices distributed on a network and accessed using a network. In some examples, the storage device may store long-term data, such as isolated pump vibration data. Preset settings corresponding to the material placed within the containment center may also be stored. The input/output interface devices 814 provide input/output operations for the system 800. In some implementations, the input/output interface devices 814 can include one or more of a network interface devices, e.g., an Ethernet interface, a serial communication device, e.g., an RS-232 interface, and/or a wireless interface device, e.g., an 802.11 interface, a 3G wireless modem, an 8G wireless modem, etc. A network interface device allows the system 800 to communicate, for example, transmit and receive such data. In some implementations, the input/output device can include driver devices configured to receive input data and send output data to other input/output devices, e.g., keyboard, printer and display devices 860. In some implementations, mobile computing devices, mobile communication devices, and other devices can be used.

A server or database system 802 can be distributively implemented over a network, such as a server farm, or a set of widely distributed servers or can be implemented in a single virtual device that includes multiple distributed devices that operate in coordination with one another. For example, one of the devices can control the other devices, or the devices may operate under a set of coordinated rules or protocols, or the devices may be coordinated in another fashion. The coordinated operation of the multiple distributed devices presents the appearance of operating as a single device.

In some examples, the system 800 is contained within a single integrated circuit package. A system 800 of this kind, in which both a processor 804 and one or more other components are contained within a single integrated circuit package and/or fabricated as a single integrated circuit, is sometimes called a microcontroller. In some implementations, the integrated circuit package includes pins that correspond to input/output ports, e.g., that can be used to communicate signals to and from one or more of the input/output interface devices 812.

### End-to-End Wireless Sensor-Hub System

Industrial equipment includes any number of components to achieve a predetermined objective, such as the manufacture or fabrication of goods. A sensor, such as the sensor 120 of FIG. 1A, can be one or more sensors as described below. For example, a sensor 120 can be included in a sensor hub. A sensor hub according to the present systems and techniques captures data associated with industrial equipment and transmits the data as needed. In some embodiments, the sensor data is used to train one or more machine learning models. In some embodiments, the sensor data is input to a trained machine learning model to characterize the operation of the industrial equipment.

The present systems and techniques include an end-to-end wireless sensor hub system. One or more sensor-hubs ingest raw sensor data captured by multiple sensors. In some embodiments, sensor data includes multiple rotating component speeds, system current consumed by operating parts, machine vibration and orientation, operating temperature, and any other suitable characteristics that the industrial equipment can exhibit. In examples, the multiple sensors include sensors that capture current, power, and ambient conditions. The multiple sensors can also include temperature sensors, inertial measurement units (IMUs) and the like. The one or more sensor hubs are physically coupled with industrial equipment, including but not limited to pumps, heavy duty industrial tools, compressors, automated assembly equipment, and the like. The industrial equipment can further include machines such as turning machines (e.g., lathes and boring mills), shapers and planers, drilling machines, milling machines, grinding machines, power saws, cutting machines, stamping machines, and presses.

In some embodiments, the sensor data is captured by one or more sensors of a sensor hub and sensor data is transmitted to condition monitoring applications for predictive maintenance of the industrial equipment, e.g., predictive maintenance of actuators used in the transportation sector, such as for fleet management for fuel tank systems, motion platforms, automation systems used in garbage trucks, etc. In some embodiments, a respective mounting position of each sensor-hub on the industrial equipment is determined by a series of trials that characterize various ‘anomalous conditions’ that occur throughout the lifetime of use of the equipment. The sensor data collected during these trials can be used to train machine learning models. Some mounting positions capture sensor data that do not accurately characterize operation of the industrial equipment. In particular, some mounting positions fail to capture data that enables a machine learning model to characterize the operation of the industrial equipment due to being remote from the source of sensor data. The mounting positions that fail to capture sensor data that characterizes operation of the industrial equipment are not used.

Once suitably positioned, the sensor-hubs can transfer captured raw sensor data using a low-power wireless personal area network with secure mesh based communication technology. The network can include one or more router nodes, terminating at an internet of things (IOT) edge device. In some embodiments, the network enables communications according to an Internet Protocol version 6 (IPv6) communications protocol. In particular, the communications protocol used enables wireless connectivity at lower data rates. In some embodiments, the communications protocol used across the network is an IPV6 over Low-Power Wireless Personal Area Networks (6LoWPAN). The sensor data is ingested into a workflow and one or more trained machine learning models learn from the sensor data for continuous improvement. In some embodiments, the trained machine learning model(s) are deployed onto edge or cloud devices. In some embodiments, the edge devices are deployed at an operational site. The sensor hubs enable low power data collection and transmission, thereby conserving power consumption. The mesh network used for data transfer is resilient to failures and handles outages of member nodes.

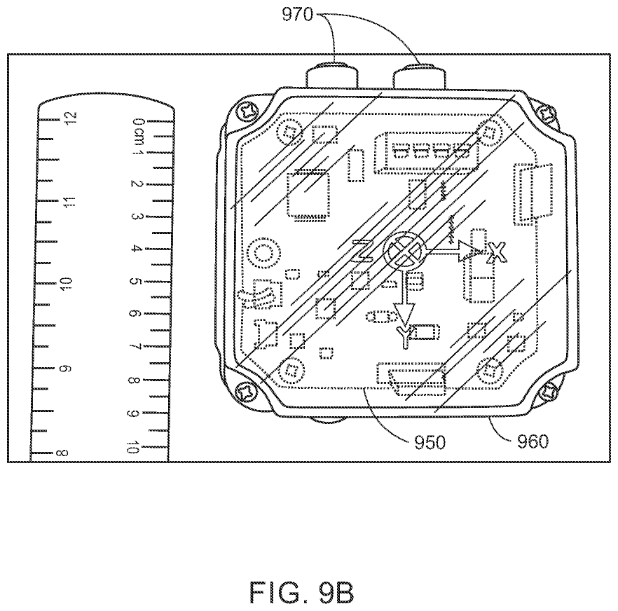

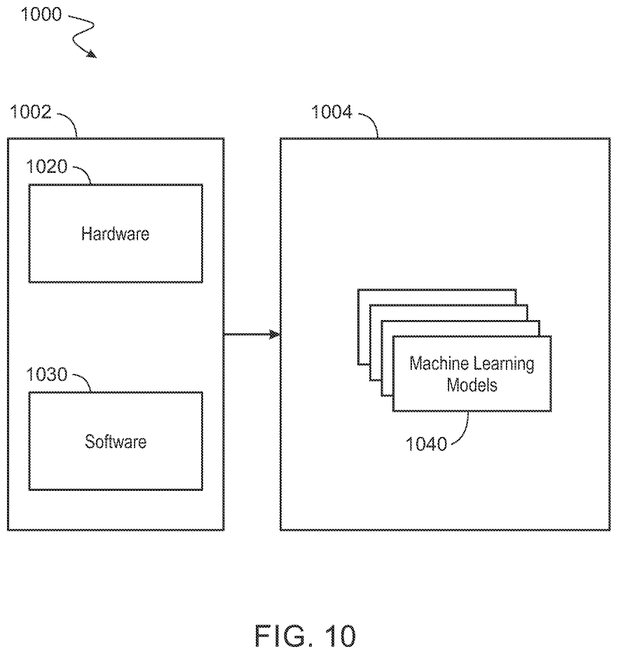

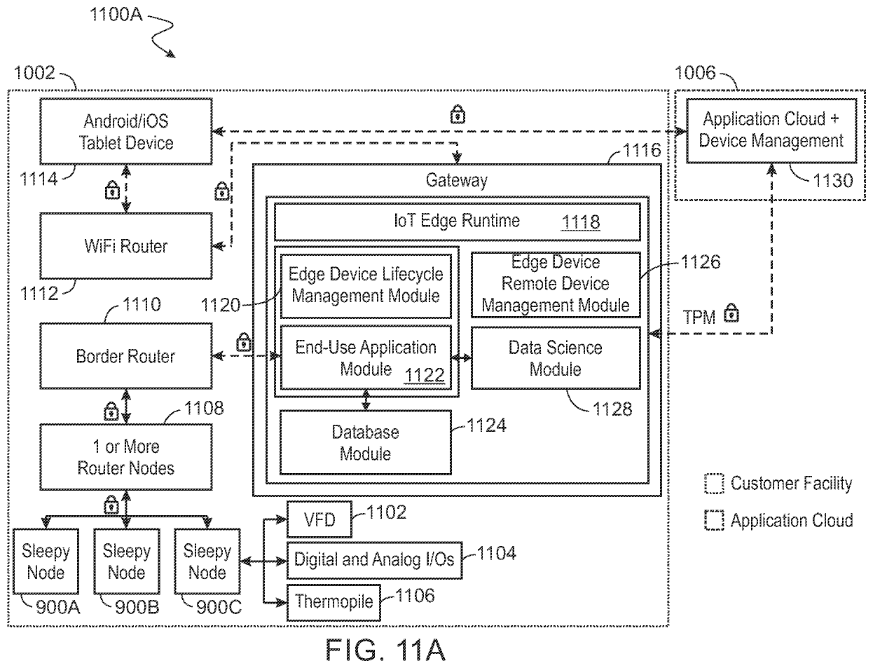

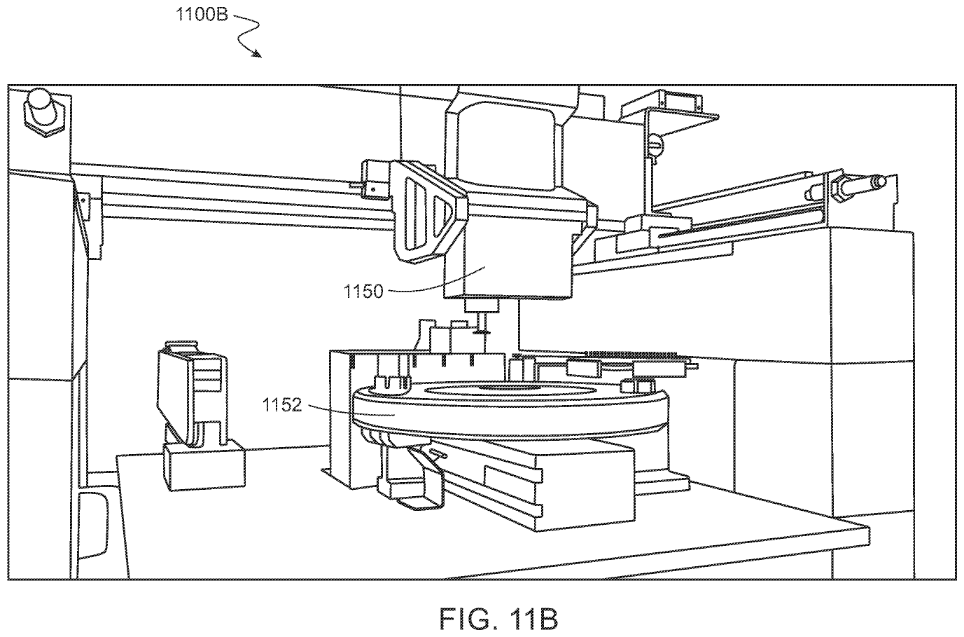

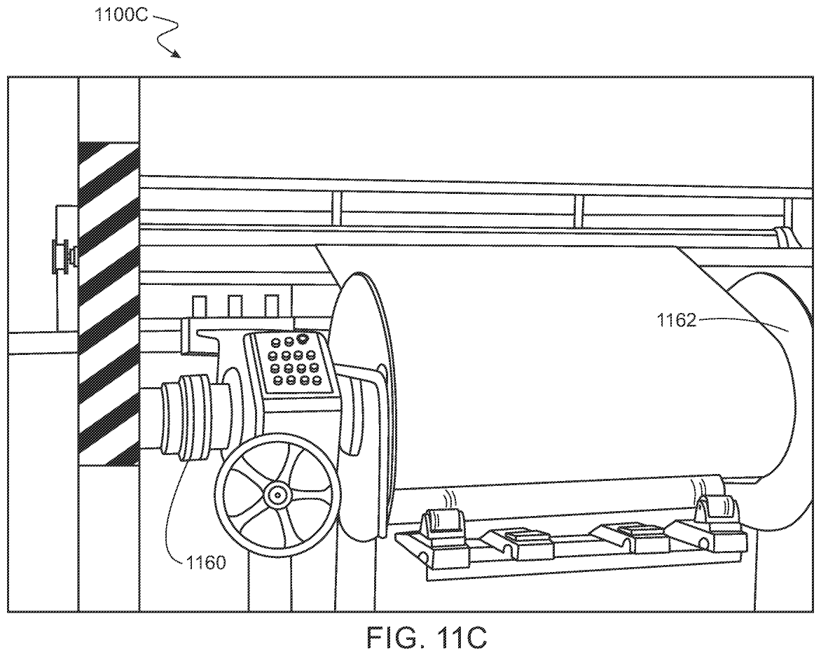

FIG. 9A shows an example of a sensor hub 900. The sensor hub 900 captures sensor data that is input to the data flow architecture 1000 of FIG. 10. A sensor hub 900 corresponds to each of the nodes 900A, 900B, and 900C of the network 1100A of FIG. 11A, and a sensor hub 900 can be placed at various positions as shown in the example of the computer numerically controlled (CNC) machine 1100B of FIG. 11B and/or the industrial machine 1100C of FIG. 11C. Note that the CNC 1100B and industrial machine 1100C are examples, and the industrial equipment (including the CNC 1100B and the industrial machine 1100C) can be designed and built to perform a single operation or be designed and built to perform a combination of two or more operations. In any case, the industrial equipment can perform one or more operations that generate multiple functional parameters that can be understood by a trained machine learning algorithm through the use of various data inputs, as described in this specification. In some embodiments, two or more sensor hubs 900 are coupled with the industrial equipment.

In the example of FIG. 9A, the sensor hub 900 includes a controller 902. The controller 902 includes one or more processing cores and memory. In some examples, the controller 902 is a system on a chip (SoC). As shown, the controller 902 is a mixed signal controller that integrates both analog and digital inputs. Analog inputs 906 are provided to the controller 902. The controller 902 outputs analog outputs 908. Similarly, the controller 902 receives digital inputs 910. The controller 902 outputs digital outputs 912. The controller 902 also communicates via a serial RS-485 interface 904. Additionally, the controller 902 includes future expansion 914. In some embodiments, the future expansion 914 is an expansion bus. The expansion bus may be for example, an Inter-Integrated Circuit bus (I2C). In some examples, the future expansion 914 enables lower speed peripheral components to be communicatively coupled with the controller 902.

The controller 902 includes or is coupled with a battery 916. In examples, the battery 916 is rechargeable or replaceable. In some embodiments, the controller 902 is coupled with one or more sensors. In the example of FIG. 9A, the sensors include an inertial measurement unit (IMU) 918 and a temperature sensor 920. Although particular sensors 918 and 920 are shown in the example of FIG. 9A, any suitable sensor can be included in the sensor hub 900. In some examples, the IMU 918 includes a gyroscope, accelerometer, magnetometer, or any combinations thereof. In operation, the IMU 918 captures accelerations or other movement data associated with the industrial equipment. The temperature sensor 920 captures temperature data associated with the industrial equipment. Other suitable sensors may be, for example pressure, humidity, current, voltage, particle count, flow-rate, level measurement, speed, distance, proximity detection, up-down count, etc.

The controller 902 is communicatively coupled with the interface 904. In the example of FIG. 9A, the interface 904 is operable according to an RS-485 standard. RS-485 is a standard defining the electrical characteristics of drivers and receivers for use in serial communications systems. RS-485 specifies the electrical characteristics of a generator and receiver. It does not specify or recommend any communications protocol. In some embodiments, RS-485 is a transmission standard that uses differential voltages to code transmission data for multipoint, multi-drop LAN systems. The sensor-hub can use the RS-485 interface to communicate directly with equipment like variable frequency drives, programmable logic controllers (PLCs), and other industrial control equipment.

In some embodiments, the sensor hub includes fewer or additional components than those provided in the example of FIG. 9A. In a first example, a sensor hub 900 includes an accelerometer and a temperature sensor, is battery operated, and uses a very-low power design approach. In a second example, an analog-only sensor hub 900 includes an accelerometer and a temperature sensor, is not battery operated, and also enables users to connect multiple external analog sensors, thus extending the capability of the sensor hub 900. In some embodiments, an analog only sensor hub includes multiple analog outputs and an RS-485 port. In a third example, a fully-loaded sensor hub 900 extends the features of the analog-only sensor hub described in the second example, and additionally enables multiple digital inputs, multiple digital outputs and an expansion bus (I2C).

FIG. 9B is a drawing of a sensor hub 950. The sensor hub 950 can be, for example, the sensor hub 900 described with respect to FIG. 9A. The sensor hub 950 can include components described with respect to the sensor hub 900 in a plastic enclosure 960. The sensor hub 950 and the plastic enclosure 960 are small. In examples, the sensor hub 950 and plastic enclosure 960 are less than or equal to 83 millimeters (mm)×83 mm×39 mm for a sensor hub that is fully loaded or an analog-based sensor hub. In examples, the sensor hub 950 and plastic enclosure 960 are less than or equal to 83 mm×83 mm×55 mm for a sensor hub that is battery operated. The small size of the sensor hub 950 and plastic enclosure 960 along with the wireless communication of the sensed data facilitates placement of the sensor hub 950 and plastic housing 960 in many different locations on industrial equipment, including hard to reach locations. In some embodiments, the sensor hub 950 and plastic enclosure are mounted to the industrial equipment using stud mounting or two-pole magnetic mounting, depending on the equipment being monitored. In the example of FIG. 9B, IP67 waterproof M12 connectors 970 are shown. In some embodiments, the IP67 waterproof M12 connectors 970 enable coupling the power supply, analog and digital inputs/outputs, RS485, and I2C with the sensor hub.

FIG. 10 is a block diagram of a data flow architecture 1000 for sensor hub implementation. In the example of FIG. 10, the sensor hubs may be, for example a sensor hub 900 as shown in FIG. 9A. An operational site 1002 represents a location where industrial equipment is located. For example, the operational site 1002 may be that of an organization that owns or operates industrial equipment. Hardware 1020 and software 1030 are located at the operational site 1002. In examples, the hardware 1020 includes one or more sensor hubs. Sensor data is captured at the operational site 1002 and transmitted to a cloud infrastructure 1004.

The cloud infrastructure 1004 includes one or more trained machine learning models 1040. In some embodiments, the machine learning models are an ensemble-based model trained to predict an operating condition of the industrial equipment based on sensor data captured during operation of the industrial machinery. Trained machine learning models can also detect model accuracy and data drifts. Additionally, the trained machine learning models are self-learning, where the models are updated based on newly available sensor data. In some embodiments, trained machine learning models are deployed in the cloud infrastructure 1004, where the trained machine learning models predict an operating condition of the industrial equipment in an online manner (e.g., with cloud access). In some embodiments, trained machine learning models are deployed at the operational site 1002, where the trained machine learning model predicts an operating condition of the industrial equipment in an offline manner (e.g., without access to a cloud infrastructure).

The sensor data is labeled to characterize the subtle differences or trends that appear over a period of use, e.g., over the lifetime of use of the industrial equipment. In some embodiments, the labels are acquired via periodic polling from control equipment (including PLCs, variable frequency drives (VFDs), pump controllers, refrigeration controllers, building management system (BMS), etc.) for a state associated with the industrial equipment. In some embodiments, the labels are acquired via manual inputs from the equipment operator(s) (including truck drivers, service technicians, maintenance personnel, shop-floor supervisors, fleet operators, CNC (computer numerically controlled) machine operators, etc.) using the provided user interface running on a portable tablet device (e.g., device 1114 of FIG. 11). Over a period of time, after collecting several cycles of sensor data from the industrial equipment as it operates and degrades, the machine learning models can be trained using the labeled sensor data. This degradation during operation thus produces “anomalous conditions” that exhibit a physically measurable (using attached sensors) data footprint that is different from the data footprint when the industrial equipment is new, freshly mounted/installed, and configured according to manufacturer specifications. With enough cycles of usage, the machine learning models can distinguish between good sensor data, various levels of degradation, and bad sensor data. In examples, good data includes properly installed pumps running without any cavitation, rotary equipment used in cutting operations that produce the “right” quality of cuts of media being operated on, rotary equipment used in surface-finish operations that produce the “right” surface-finish, etc. In examples, bad data includes improperly installed pumps, pumps running dry over a long time, pumps producing lots of cavitation, rotary equipment used in cutting operations that produce “bad” quality cuts, rotary equipment used in surface-finish operations that produce “bad” quality surface-finish, etc. In some embodiments, the sensor data is captured across multiple operational sites (e.g., multiple customer installations). In some embodiments, the data is transmitted from the operational site 1002 to the cloud infrastructure 1004 according to a secure communication protocol. In some embodiments, the protocol is the Advanced Message Queuing Protocol (AMQP) or the MQTT protocol according to the OASIS Message Queuing Telemetry Transport Technical Committee.

FIG. 11A is a block diagram of an edge architecture operable via a network 1100A that includes one or more sensor hubs. In some embodiments, the network 1100A is a low power, peer-to-peer, multi-hop wireless network, wherein nodes of the network collectively coordinate routing of frames across the network. The present systems and techniques include a power-optimized sensor hub platform and an end-to-end support ecosystem for machine learning prediction completely offline and at the edge. In some embodiments, cloud connectivity is optional. In some embodiments, trained machine learning models (e.g., machine learning models 1040 of FIG. 10) can be deployed at the operational site 1002. In particular, the machine learning models are deployed at a device 1114 located at the operational site 1002. Secure communication pathways are shown in FIG. 11A with a lock adjacent to the arrow representing the communication pathway. In examples, secure communication pathways are enabled via a trusted platform module (TPM).

The network 1100A includes nodes 900A, 900B, and 900C. Each of the nodes 900A, 900B, and 900C represent a respective sensor hub (e.g., sensor hub 900 and/or sensor hub 950 of FIGS. 9A and 9B). The sensor hubs are positioned at predetermined locations on or near the industrial equipment. FIG. 11B is a drawing of a computer numerically controlled (CNC) machine 1100B. FIG. 11C is a drawing of an industrial machine 1100C. Sensor hubs, such as sensor hubs corresponding to nodes 900A, 900B, and 900C may be placed at predetermined locations with respect to the CNC 1100B and industrial machine 1100C. The sensor hubs are located adjacent to components of the CNC 1100B and industrial machine 1100C that are sources of sensor data. In some embodiments, a position and an orientation of the at least one sensor hub enables capture of sensor data associated with the component and avoids attenuation (e.g., reduction in amplitude) of the sensor data due to a distance between the component and the at least one sensor hub. In some embodiments, installation technicians (e.g., technicians that install sensor hubs at locations on or near the industrial equipment) can utilize the provided commissioning user interface tool (e.g., device 1114). The tool can report the quality of the signal dynamically to determine the best mounting position or if signal routers have to be installed between the sensor-hub and the gateway.

In some embodiments, a source of sensor data is a source of energy that moves or controls a component of the industrial equipment. In the example of FIG. 11B, the CNC 1100B includes components such as a cutter and a motorized maneuverable platform. Sensor hubs are located at a predetermined location 1150 on or near the cutter of the CNC 1100B, and a predetermined location 1152 on or near a motor of the motorized maneuverable platform of the CNC 1100B. The cutter and the motorized maneuverable platform are sources of sensor data that is captured by sensors of one or more sensor hubs. In the example of FIG. 11C, the industrial machine 1100C includes components such as a motor and a feed roll end. Sensor hubs are located at a predetermined location 1160 on or near the motor of the industrial machine 1100C, and a predetermined location 1162 on the side of the drive shaft opposite to the motor end of the rotor on the industrial machine 1100C. The motor and the feed roll end are sources of sensor data that is captured by sensors of one or more sensor hubs.

Referring again to FIG. 11A, an operational site 1002 and a cloud infrastructure 1006 is shown. In some embodiments, the cloud infrastructure 1006 is a Microsoft Azure cloud. In examples, a Modbus Remote Terminal Unit (RTU) protocol is used to for communications with the sensor hub via the RS-485 physical bus (e.g., interface 904 of FIG. 9A). The sensor hubs are driven by a variable frequency drive 1102. Inputs/outputs 1104 correspond to analog inputs 906, analog outputs 908, digital inputs 910, and digital outputs 912 as described with respect to FIG. 9A. In examples, inputs/outputs 1104 include inputs such as digital inputs (used for on/off type inputs), analog inputs (used for reference inputs like temperature reference, speed reference, etc.), RS485 inputs (used for Modbus RTU communication with PLC, etc.) and I2C input (used for future expansion). In examples, inputs/outputs 1104 include digital outputs (used to turn an indication light on/off or start/stop something) and analog outputs (used to provide reference to an externa system, like used to control the speed of a motor, etc.) In an exemplary sensor hub, there are four digital inputs, four analog inputs, one RS-485 input, and one I2C input. The exemplary sensor hub also includes four digital outputs and two analog outputs.

A thermopile 1106 is used to capture surface temperature of the media under operation. This surface temperature data is used to train machine learning models. In some examples, the temperature of the media affects the output quality of the process. Media refers to anything that is being operated upon. For example, in a CNC machine, media is a block of metal that needs to be machined. In other examples, such as a pelletizer, media is strands of extruded plastic that needs to be cut to form pellets. In the example of a paper cutter or textile cutter, media is paper and textile respectively.

The nodes 900A, 900B, and 900C capture sensor data associated with industrial equipment and transmit the sensor data using the network 1100A. In some embodiments, the network 1100A is an IPV6-based network. In examples, the network 1100A is an OpenThread network (e.g., 802.15.4 Thread) that routes data from one or more sensor hubs across the network consisting of one or more router nodes that form the mesh. In examples, the network 1100A is a Matter network as provided by the Connectivity Standards Alliance. In examples, the network 1100A is a Bluetooth Low Energy (LE) network as provided by the Bluetooth Special Interest Group. In examples, the network 1100A is a Bluetooth mesh network as provided by the Bluetooth Special Interest Group. In examples, the network 1100A is a Zigbee network as provided by the Connectivity Standards Alliance. In examples, the network 1100A is an ANT Network as provided by the ANT+ Alliance. In examples, the network 1100A is a proprietary 2.4 GHz networking protocol, developed in-house.

In the example of FIG. 11, the network 1100A is an IPV6-based, low-power mesh networking technology for IOT devices, and is secure and future-proof. In some embodiments, the sensor hubs (e.g., sensor hubs 900, 950 of FIGS. 9A and 9B) are located in a high temperature industrial environment. High temperature may be, for example, up-to 130° C. The low power IP based smart mesh network is operable in the high temperature industrial environment by isolating the electronics (e.g., processor, peripheral silicon devices and networking radio) from a transducer (e.g., device that converts energy to an electric signal) of the sensor hub. The isolation enables the electronics to operate at a reduced temperature at up-to 85° C. when compared to the high temperature industrial environment. As described herein, intelligent sequencing enables large data transfer from multiple sensor-hubs. The sensor hubs communicate according to a predefined protocol that enables each sensor hub to participate in the data transmission on the network. Each sensor hub is an endpoint of the network that transmits captured sensor data via one or more router nodes 1108 to finally reach the IoT gateway 1116. This data can include metrics from sensors such as an accelerometer, temperature sensor, RS-485 (data from variable frequency drives, PLCs, etc.)

The one or more router nodes 1108 transmit sensor data captured at the sensor hubs corresponding to nodes 900A, 900B, and 900C. In examples, the network 1100A includes multiple types of nodes. For example, a node can be a full thread device (FTD), a minimal thread device (MTD), or any combinations thereof. An FTD includes a radio that is always on, while an MTD includes a radio that is periodically placed in a sleep state. In the example of FIG. 11A, the nodes 900A, 900B, and 900C are a type of MTD referred to as a sleepy node. A sleepy node optimizes power consumption by waking up from a sleep mode for a brief amount of time during which it does end-use application specific tasks. Upon completion of the tasks, the sleepy node returns to a sleep state. The longer a node sleeps, the more power is conserved.

The one or more router nodes 1108 transmit data to the border router 1110. The sensor data is wirelessly transmitted to the router nodes 1108, which relay information to the border router 1110. The border router 1110 translates between the IPV4 network (e.g., the Internet) to which a gateway 1116 is connected, and the IPV6 network. Data moving between the nodes 900A, 900B, and 900C and the cloud infrastructure 1006 are transmitted through the gateway 1116. The border router 1110 is positioned at an edge of the network 1100A, and in some embodiments, the border router 1110 routes data between the low-power mesh network 1100A and an external network, such as the Internet. The border router 1110 enables connectivity of nodes on the low-power mesh network 1100A to other devices in external networks or to the cloud infrastructure 1006. As shown, the border router 1110 is communicatively coupled to an IoT gateway 1116. The border router 1110 transmits sensor data to the IoT gateway 1116, and the IoT gateway 1116 to the device 1114. In examples, the device 1114 is a tablet computer, cellular phone, laptop, or other mobile electronic device. In some embodiments, the device 1114 operates using an Android or iOS based operating system. In some embodiments, a rate of data sampling for each node 900A, 900B, and 900C is configurable via the device 1114. The device 1114 and gateway 1116 are communicatively coupled with the cloud infrastructure 1006 via a WiFi router 1112. In some embodiments, the device 1114 and gateway 1116 communicate with the cloud infrastructure 1006 using Long-Term Evolution (LTE) or Wi-Fi communication standard. The cloud infrastructure 1006 includes application cloud and device management 1130. In some embodiments, an application cloud is used to display data in a central web dashboard so that an engineer or customer can look at machine trends over time to understand degradation of machine tools. In some embodiments, device management includes a web application used to manage lifecycle of the IoT devices deployed at customer sites. Management, for example, includes deploying a new device, over-the-air software updates, rebooting an unresponsive device remotely, etc.

In some embodiments, the gateway 1116 is hardware and/or software a program that is a connection point between the cloud infrastructure 1006, various controllers, nodes 900A-900C, and other devices on the network 9100A. The gateway 9116 can execute a software library that enables edge functionality on the network. For example, the gateway 1116 can execute a Microsoft IoT Edge runtime, which enables predictive monitoring applications and the associated machine learning models (e.g., machine learning models 1040 of FIG. 10). The device 1114 is connected on the IPV4 network and acts as the user interface to securely onboard and provision new sensor-hubs on the low-power mesh network, add users with Role Based Access Control (RBAC), send configuration updates to the sensor-hubs, send over-the-air update firmware for the sensor-hubs, and manually label data for machine learning model training. In some embodiments, outputs from the machine learning models are visually indicated via one or more lights (e.g., “traffic” lights) connected to the digital outputs of the sensor hub.

In some embodiments, the gateway 1116 processes the sensor data locally at the edge before transmitting it to the cloud infrastructure 1006. For example, the gateway 1116 can aggregate or de-duplicate the sensor data as a way of reducing the volume of data that is transmitted to the cloud infrastructure 1006. In some embodiments, the gateway 1116 provides security to the network. In the example of FIG. 11A, the gateway 1116 includes an IoT Edge Runtime 1118, Edge Device Lifecycle Management Module 1120, End-Use Application Module 1122, Database 1124, Edge Device Remote Device Management Module 1126, and Data Science Module 1128. In some embodiments, the IoT Edge runtime 1118 enables deploying IoT workloads on an IoT gateway. The IoT Edge runtime 1118 may be, for example, a Microsoft Azure product. In some embodiments, an Edge Device Lifecycle Management Module 1120 includes a proprietary application that manages the lifecycle of an IoT gateway. Managing the lifecycle of the gateway includes, for example, deploying the gateway from scratch, receiving and processing over-the-air software updates, etc. An End-Use Application module 1122 is a proprietary application that handles data coming in from the sensor hubs. In some embodiments, the End-Use Application Module 1122 transmits data from sensor hubs to the cloud for training machine learning models. The End-Use Application Module 1122 also executes the machine learning model to perform predictions on-premise and locally. In some embodiments, the Database Module 1124 stores data captured by the sensor hubs in a database.

In some embodiments, the peak data throughput of the low-power networking protocol used for communication between the nodes 900A-900C and the gateway 1116 without using any routers between them is 250 kilobits per second (kbps). Large amounts of raw, unprocessed data from multiple sensors on-board each sensor-hub can be captured from multiple such sensor-hubs for training the machine learning models. In some embodiments, the raw, unprocessed data is captured from multiple sensor hubs for input into trained machine learning models. In some embodiments, a smart data transfer mechanism assigns a sequence number and a group number to each sensor hub during onboarding. The gateway ensures that at a given point in time, a predetermined number of sensor-hubs are allowed to transfer data while all other sensor-hubs are in a halted mode. Sensor hubs in a halted mode are presumed ready to initiate data transfer upon request. The data transfer mechanism ensures that no single sensor-hub consumes the available bandwidth on the network for an extended period of time. The data transfer mechanism provides each sensor-hub an opportunity to transfer sensor data captured by one or more sensor-hubs at least once per data acquisition cycle. In some embodiments, the data acquisition cycle is a predetermined time interval. For example, the data acquisition cycle is of a duration that enables capture of sensor data as fast as possible (e.g., in view of hardware and software limitations) which could be one transmission of the entire payload once every five seconds, while collecting as many samples as possible which can be as low as required or can be changed to continuous sampling, and with as high sampling frequency as possible which can be up-to 32 KHZ. Data acquisition cycle balances wireless throughput and sampling time, so that exactly the required amount of data is sampled at the optimal frequency that enables full characterization of the signatures produced by “good” operating conditions vs “bad” operating conditions. This facilitates training of the machine learning model(s), as well as continuous improvement of trained machine learning model(s), and also ensures that the data payload per recording cycle of each sensor-hub is maintained at an optimal level to avoid overwhelming the low-power mesh network.

In some embodiments, a current group of sensor-hubs is active while the remaining groups of sensors are in a halted mode. If a sensor-hub does not initiate data transfer during its active mode for more than a specified time, for example, thirty seconds, then the gateway can enable an additional time window for the sensor-hub to transmit sensor data captured by one or more sensors of the sensor-hub before which the sensor-hub will lose its chance to transfer data collected in the current recording cycle. Additionally, if the sensor hub enters an offline mode while it is transmitting sensor data as a member of the current group for data transmission, the gateway 1116 marks the received data as incomplete and the sensor-hub will get another chance to retry data transmission. After a predetermined number of opportunities to transmit data from the sensor hub, if the sensor-hub is still unresponsive, the data is marked invalid and the user/machine operator is notified via the device 1114.

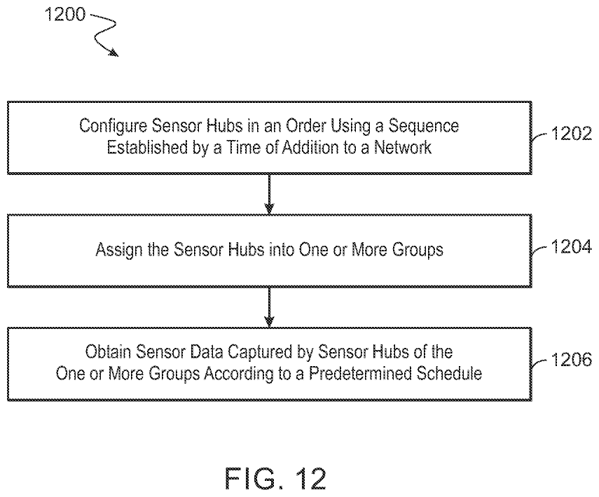

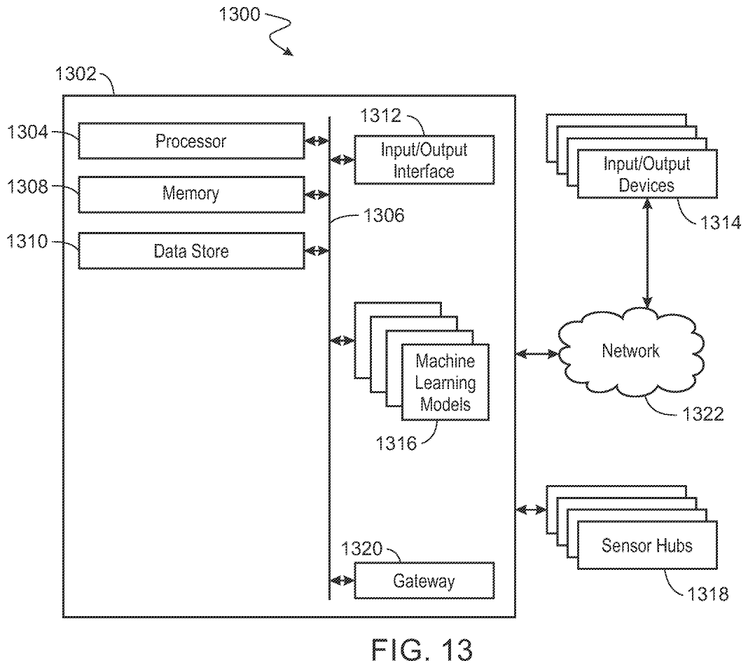

FIG. 12 shows a process 1200 that enables an end-to-end wireless sensor-hub system. The process 1200 is operable using the sensor hub 900 of FIG. 9A, sensor hub 950 of FIG. 9B, the data flow architecture 1000 of FIG. 10, and/or the network 1100A of FIG. 11A. The process 1200 can be executed by the system 1300 of FIG. 13. At block 1202, sensor hubs are configured in an order using a sequence established by a time of addition to a network. In some embodiments, a sequence number is the number assigned to a sensor hub when the sensor hub is initially added to the network (e.g., network 1100A of FIG. 11A). For example, a first sensor hub added at the earliest time of addition to the network is designated as sensor hub #1, a second sensor hub added at a second earliest time of addition to the network is designated as sensor hub #2, a third sensor hub added at a third earliest time of addition to the network is designated as sensor hub #3, and so on. In some embodiments, the sequence number is assigned by the network gateway (e.g., gateway 1116 of FIG. 11A). In some embodiments, each sensor hub includes analog inputs and outputs, digital inputs and outputs, an internal temperature sensor, flash memory, RS-485, an I2C expansion bus and a trusted platform module (TPM). In some embodiments, the sensor hub is battery powered. In some embodiments, the sensor hub is powered by field power supply (DC 24V supply).

At block 1204, the sensor hubs are assigned to one or more groups. In some embodiments, the sensor hubs are assigned to a group by the gateway of the network. A number of sensor hubs in a respective group is calculated according to a maximum bandwidth consumed by a group of sensor hubs, wherein the maximum bandwidth does not exceed a data bandwidth (e.g., throughput at the thread border router) of the network. For example, to avoid multiple sensor hubs sending data simultaneously and creating a bottleneck on the low-power wireless network, the data bandwidth of the network is divided among a number of sensor hubs. The maximum number of sensor hubs that can transmit data simultaneously on the network without causing a bottleneck is the group size. For purposes of example, each group can include three sensor hubs. In this example, sensor hubs assigned sequence numbers #1, #2 and #3, are assigned to group #1. Sensor hubs with sequence numbers #4, #5 and #6 are assigned to group #2. Sensor hubs transmit sensor data when their group number is the current group number as provided by the gateway. Otherwise, the sensor hubs are placed in a halted mode. Other maximum number of sensor hubs per group can also be used, such as a maximum of two or four sensor hubs per group.

At block 1206, sensor data (e.g., IMU data (accelerations, orientation), temperature data) captured by sensor hubs of the one or more groups is obtained according to a current group number. The sensor data is obtained from sensor hubs in each group of the one or more groups according to a predetermined schedule. In some embodiments, a round robin scheduling is used to cycle between sensor hubs by group numbers to obtain sensor data. When a particular group number becomes current, then the sensor hubs within that group start sending data. In some embodiments, the scheduling is manual scheduling according to a predetermined order.

Each sensor hub added to the network periodically transmits a heartbeat message to the gateway. For example, the time period for transmission of the heartbeat message may be once every five seconds. The gateway communicates with the sensor hubs via a response message to the heartbeat message. The response message may include, for example, commands and statuses such as start data transmission, stop data transmission, firmware update required, and the like. The gateway application cycles between groups of sensor hubs according to the predetermined schedule. When a group is the current group, the sensor hubs assigned to the current group receive a response message that includes a command to initiate sensor data transmission in response to their respective heartbeat message. All other sensor hubs that belong to groups other than the current group receive a halted message (e.g., stop data transmission command) in response to their heartbeat message.

For the current group, the gateway waits for a predetermined time period (e.g., 30 seconds) to receive a heartbeat message from the sensor hubs of the current group. Heartbeat messages are periodically sent by each sensor hub regardless of the assigned group. In examples, the heartbeat messages are sent once every 5 seconds. This prevents a situation where a sensor hub belonging to a particular group goes offline and causes a delay in response, in which case, it does not send the heartbeat message. This also prevents a situation where a sensor hub initiates transmission of sensor data but does not complete the transmission of data. Obtaining sensor data captured by the one or more groups includes transmitting a start data transmission command in response to a heartbeat message received from a current group of sensor hubs.

When the sensor hub is a member of the current group and transmitting data, sensor data can be partitioned into multiple frames to accommodate a maximum transfer unit (MTU) of networking protocol (e.g., Thread protocol). In examples, when the sensor hub includes an accelerometer, 4000 individual accelerometer data points (x, y, z values of acceleration) are sampled. However, transmission of the samples may be constrained by networking protocols. In the example of a Thread protocol, a maximum of 50 samples can be transmitted in one frame without violating the MTU. In some embodiments, a correlation identification (ID) is assigned to a sensor hub. The correlation ID is a random number that the gateway assigns to each sensor hub the first time the sensor hub is registered on the network. For example, this assignment occurs after every reboot of the sensor hub or gateway application). This correlation ID is appended in each of the frames along with 50 accelerometer data points and sent to the gateway. Every frame which has the same correlation ID is considered to be part of the data that all belongs to the one time instance and is assembled together at the gateway to reconstruct the whole data sample. The order in which the individual frames (including 50 data points) arrive at the gateway does not change. Even if a particular frame is lost, the networking protocol ensures that frames are delivered in-order and at least once. The gateway assembles the frames in-sequence. In examples, if a particular sensor hub is offline for more than a predetermined time interval (e.g., 30 seconds) after beginning a transmission of sensor data, then the gateway will give the sensor hub a second chance to respond (e.g., an additional predetermined time interval of 30 seconds). After that, the gateway can discard the partial data received from the sensor hub, as partial data is generally not useful for analysis.

In examples, sensor hubs transmitting at the same time use the 115.2 kbps throughput of a border router. The network also transmits heartbeat messages and other messages that are internal to the network to ensure proper function of the mesh network. Transmission of sensor data across the network avoids consuming the maximum throughput of the network. For a border router with a maximum throughput of 250 kbps, more than two sensor hubs transmitting data simultaneously clogs the network, and the network failed transmissions may create an avalanche of further failures. In this example, to avoid failed transmissions, groups of sensor hubs are configured such that each group includes two sensor hubs. When a sensor hub is not a member of the current group selected for data transmission across the network, the sensor hub is in a halted mode. In some embodiments, a halted sensor hub receives a response message from the gateway of “stop data transmission” in response to their heartbeat request. The halted sensor hubs continue to transmit heartbeat messages at predetermined intervals and wait for a start data transmission response from the gateway. A sensor hub will initiate capture of sensor data after receiving a start response message from the gateway. In some embodiments, a sensor hub is placed in a low power mode when the sensor hub is not actively sampling. For example, after receipt of a “stop data transmission,” a sensor hub can enter a low power mode. The low power mode enables the sensor hub to conserve power consumption and extend battery life

FIG. 13 is a block diagram of a system 1300 that enables an end-to-end wireless sensor hub system. The system 1300 can execute the process 1200 of FIG. 12. In examples, the system 1300 includes, among other equipment, a controller 1302. Generally, the controller 1302 is small in size and operates with lower processing power, memory and storage when compared to other processors such as GPUs or CPUs. In some embodiments, the controller 1302 consumes very little energy and is efficient. In examples, the controller 1302 is a component of (or is) a mobile device, such as a cellular phone, tablet computer, and the like. In some cases, the controller 1302 is operable using battery power and is not required to be connected to mains power.

The controller 1302 includes a processor 1304. The processor 1304 can be a microprocessor, a multi-core processor, a multithreaded processor, an ultra-low-voltage processor, an embedded processor, or a virtual processor. In some embodiments, the processor 1304 can be part of a system-on-a-chip (SoC) in which the processor 1304 and the other components of the controller 1302 are formed into a single integrated electronics package.

The processor 1304 can communicate with other components of the controller 1302 over a bus 1306. The bus 1306 can include any number of technologies, such as industry standard architecture (ISA), extended ISA (EISA), peripheral component interconnect (PCI), peripheral component interconnect extended (PCIx), PCI express (PCIe), or any number of other technologies. The bus 1306 can be a proprietary bus, for example, used in an SoC based system. Other bus technologies can be used, in addition to, or instead of, the technologies above.

The bus 1306 can couple the processor 1304 to a memory 1308. In some embodiments, such as in PLCs and other process control units, the memory 1308 is integrated with a data storage 1310 used for long-term storage of programs and data. The memory 1308 can include any number of volatile and nonvolatile memory devices, such as volatile random-access memory (RAM), static random-access memory (SRAM), flash memory, and the like. In smaller devices, such as programmable logic controllers, the memory 1308 can include registers associated with the processor itself. The storage 1310 is used for the persistent storage of information, such as data, applications, operating systems, and so forth. The storage 1310 can be a nonvolatile RAM, a solid-state disk drive, or a flash drive, among others. In some embodiments, the storage 1310 will include a hard disk drive, such as a micro hard disk drive, a regular hard disk drive, or an array of hard disk drives, for example, associated with a distributed computing system or a cloud server.

The bus 1306 couples the processor 1304 to an input/output interface 1312. The input/output interface 1312 connects the controller 1302 to the input/output devices 1314. In some embodiments, the input/output devices 1314 include printers, displays, touch screen displays, keyboards, mice, pointing devices, and the like. In some examples, one or more of the I/O devices 1314 can be integrated with the controller 1302 into a computer, such as a mobile computing device, e.g., a smartphone or tablet computer.

The controller 1302 also includes machine learning models 1316. The machine learning models 1316 are trained using sensor data captured by one or more sensor hubs 1318. Sensor data from the sensor hubs 1318 is transmitted to the machine learning models 1316 using a gateway 1320. The gateway 1320 enables the controller 1302 to transmit and receive information across a network 1322. Although not shown in the interests of simplicity, several similar controllers 1302 can be connected to the network 1322.

### Proactive Prediction of Operating Conditions in Industrial Equipment

Sensor hubs capture sensor data that characterize the subtle differences or trends that appear over a period of use, e.g., over the lifetime of use of industrial equipment. Anomalous conditions of the industrial equipment exhibit a sensor data footprint that is different from the sensor data footprint when the industrial equipment is new, freshly mounted/installed, and configured according to manufacturer specifications. The sensor hubs enable proactive prediction of operating conditions in industrial equipment. Machine learning models are trained to predict an operating condition of the industrial equipment based on sensor data captured during operation of the industrial equipment. An ensemble-based model is created using the trained machine learning models, and the trained machine learning models predict an operating condition of the industrial equipment. In examples, an anomalous condition is a type of operating condition. In some embodiments, operating conditions include fretting, abrasive wear, and other conditions or any other anomalous conditions associated with typical industrial equipment like pumps, milling-drilling machines, compressors, etc.

Sensor hubs (e.g., sensor hub 900 and/or sensor hub 950 of FIGS. 9A and 9B), may be placed at predetermined locations with respect to industrial equipment (e.g., CNC 1100B of FIG. 11B or industrial machine 1100C of FIG. 11C). One or more sensor hubs are physically coupled with industrial equipment, including but not limited to pumps, heavy duty industrial tools, compressors, automated assembly equipment, and the like. The industrial equipment can further include machines such as turning machines (e.g., lathes and boring mills), shapers and planers, drilling machines, milling machines, grinding machines, power saws, cutting machines, stamping machines, and presses. Each sensor hub includes multiple sensors, such as sensor 120 of FIG. 1A.

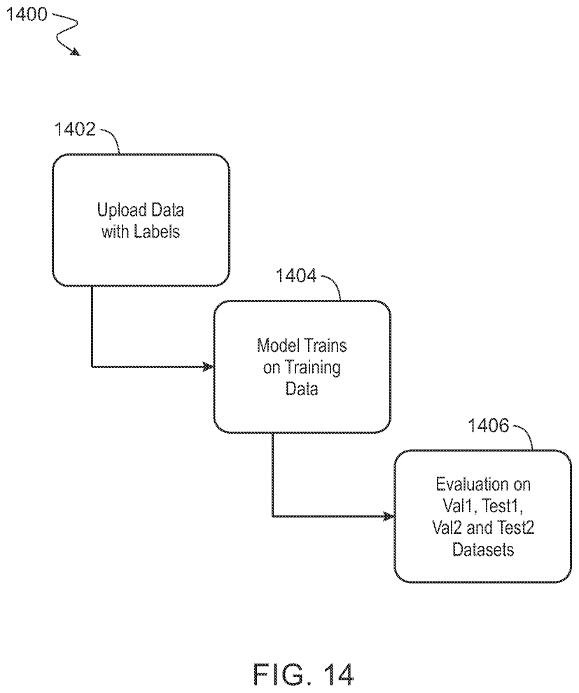

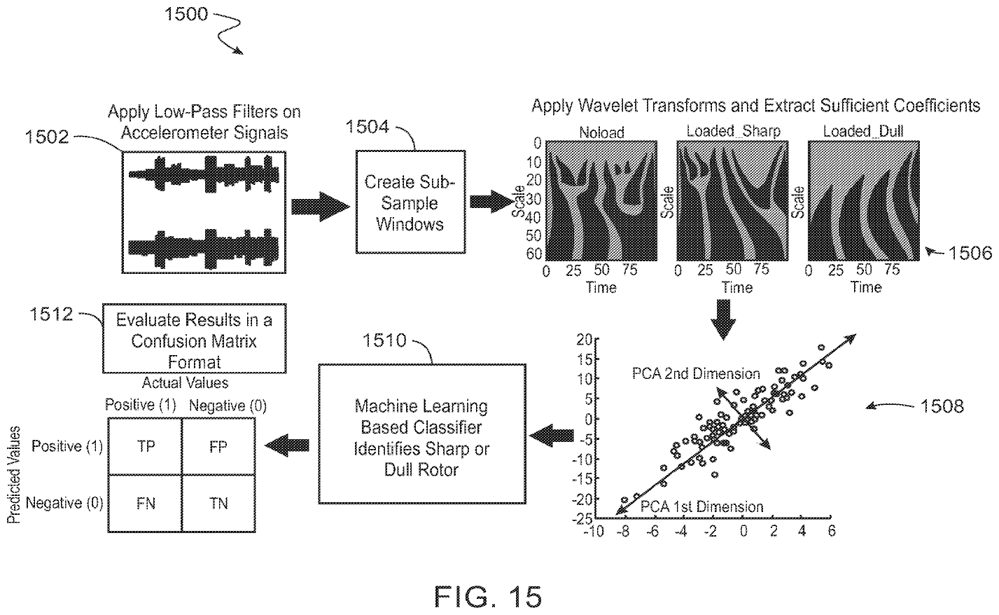

FIG. 14 shows an end-to-end model training pipeline 1400. In examples, machine learning models are trained using data generated while one or more predetermined operating conditions exist. Labeled sensor data is captured during multiple runs of experiments to isolate the effects of operating conditions of the industrial equipment. The operating conditions can include, for example, sample diameter-lengths of media, sample-media types, number of strands, feed roll speeds, cutting gaps, ambient temperatures, and the like. In examples, a speed associated with the industrial equipment can be varied using a variable frequency drive (VFD) controlling an oversized motor which provides enough horsepower to operate the industrial equipment under reduced motor speed. For example, when the industrial equipment is a cutting machine, cutting gaps can be manually adjusted using an analog caliper. Multiple sensor hubs can be used to measure data associated with the industrial equipment. In some embodiments, an auxiliary sensor is used to validate the sensor data captured by the sensor hubs. The auxiliary sensor can be an accelerometer.

At block 1402, labeled sensor data is uploaded. The sensor data is labeled to characterize the subtle differences or trends that appear over a period of use, e.g., over the lifetime of use of the industrial equipment. The labeled sensor data is preprocessed and split into multiple datasets. For example, the labeled data is split into a training dataset, a first dataset, and a second dataset. The first dataset includes a first test dataset and a first validation dataset, and the second dataset includes a second test dataset and a second validation dataset. In examples, the first dataset and the second dataset are generated based on rotor/feed roll speeds. For example, a first dataset belongs to sets of speeds which are used to train the machine learning models. The machine learning models are evaluated using the second dataset that includes unseen or unknown data.

At block 1404, the machine learning models are trained using the training dataset. The degradation during operation of industrial equipment creates anomalous conditions. The machine learning models are trained to predict operating conditions that include various levels of degradation of the industrial equipment. The models are trained on specific operating conditions and tested on unknown datasets. For example, the first dataset includes a set of feed roll speeds (e.g., specific operating conditions) included in a corresponding training dataset. In examples, the second dataset is a set of unseen/unobserved feed roll speeds (e.g., unknown datasets). In examples, an optimal number of data points are provided in the training dataset. The optimal number of data points in the training dataset is selected to ensure sufficient variabilities/parameters of the equipment are captured. For example, if sensor generates 50000 data points across each speed of the industrial equipment for the known datasets, then 70% of the 50000 data points results in 35000 data points will be included in the training dataset. The remaining 15000 data points are split into validation and test sets for known/seen speeds (e.g., the first dataset).

At block 1406, the machine learning models are evaluated using the first validation dataset, the first test dataset, the second validation dataset, and the second test dataset. In some embodiments, the best model or best ensemble based models are selected according to accuracies computed using unknown datasets. In some embodiments, the ensemble based model is comprised of features learnt from classical physics based feature-extraction techniques like wavelet transforms, Fast Fourier Transforms (FFT), power spectral density (PSD), etc. in conjunction with deep-learning based auto-features.

In the example of a model trained using a set of feed roll speeds, a machine learning model can be tested under multiple combinations of the first dataset and the second dataset, and can yield 100% accuracy in predicting a dull or sharp condition of an industrial machine with a cutter. In this example, a dull cutter is an anomalous condition, and a sharp cutter is a nominal operating condition. The trained models are subsequently executed on sensor data captured by sensor hubs during real-time operation of industrial equipment. In some embodiments, the trained models output a prediction of one or more operating conditions currently affecting the industrial equipment based on the sensor data. The sensor hubs enable low power data collection and transmission at an operational site, and the models can make predictions using this data.

The block diagram of FIG. 14 is not intended to indicate that the system pipeline 1400 is to include all of the components shown in FIG. 14. Rather, the pipeline 1400 can include fewer or additional components not shown in FIG. 14 (e.g., additional sensor data, training, validation, and testing). The pipeline 1400 may include any suitable number of additional components not shown, depending on the details of the specific implementation. Furthermore, any of the models, sensor hubs, and other described systems and techniques can be partially, or entirely, implemented in hardware and/or in a processor. For example, the functionality can be implemented with an application specific integrated circuit, in logic implemented in a processor, in logic implemented in a specialized graphics processing unit, or in any other suitable processing device.

In some embodiments, a two-layer ensemble approach for model prediction includes a first layer where sensor data is reshaped into intermediate buckets and predictions are made based on the buckets, and a second layer where an ensemble of machine learning models are used to predict operating conditions of industrial equipment.

In the first layer, the sensor data is reshaped into intermediate buckets with a predetermined size. In examples, the sensor data includes additional sensor data, additional temperature data, or a combination thereof captured during operation of the industrial equipment. Each bucket is further divided into a number of subsample windows with a predetermined size. For example, a number of buckets are generated with 500 data-points in each bucket. Each of the buckets with 500 data points is divided into 5 sub-sample windows that each contain 100 data points. Feature extraction techniques and model predictions are applied to each of the sub-sample windows. In this manner, multiple predictions can be made for each bucket. Continuing the previous example, 5 predictions are generated, where a prediction is made for each of the 5 sub-sample windows. A statistical mode (e.g., average) or voting scheme is applied to the multiple predictions from each bucket to determine a prediction for each bucket of sensor data. For example, operating conditions for each respective sub-sample window are predicted according to extracted features, where an operating condition associated with the intermediate buckets is determined according to a number of predictions associated with the sub-sample windows.

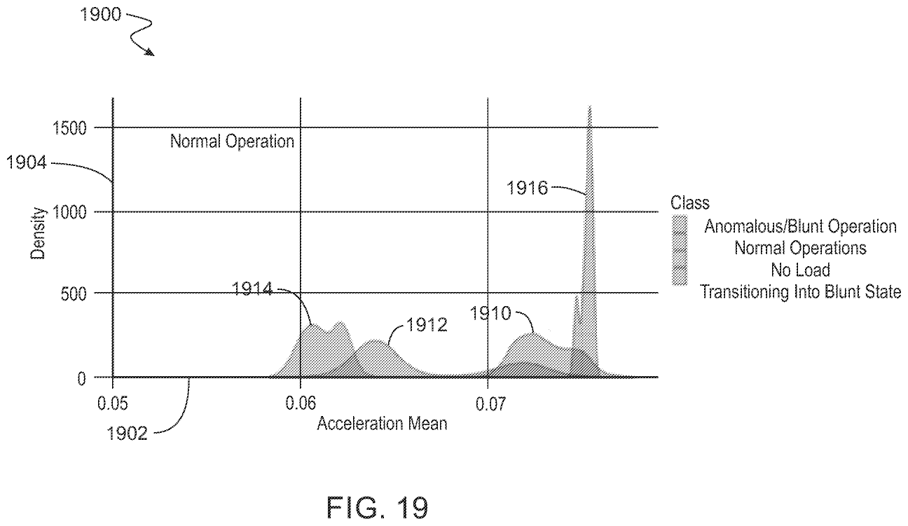

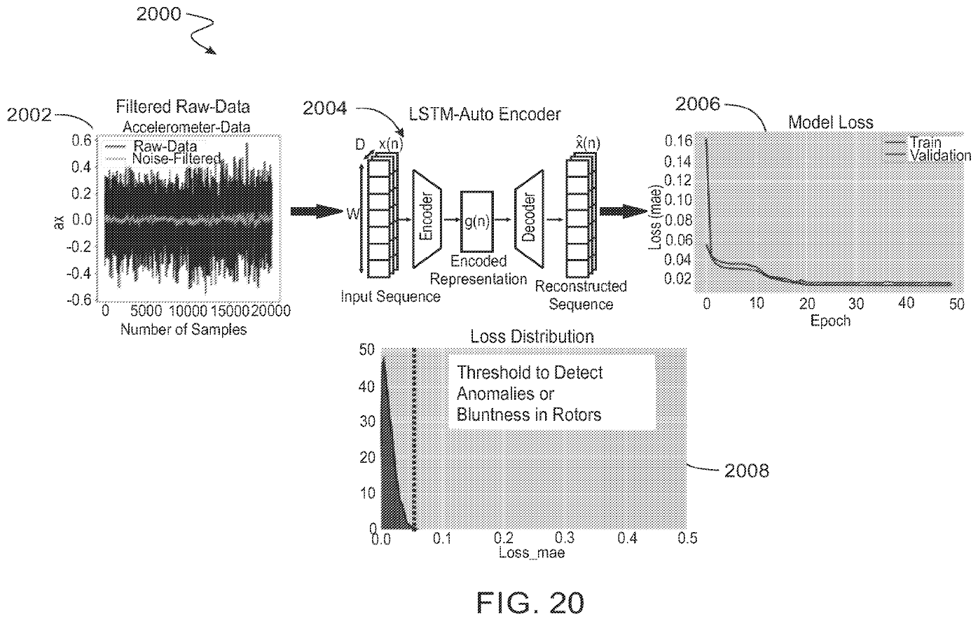

In the second layer, an ensemble of machine learning models is used to predict operating conditions of industrial equipment. The machine learning models according to the present systems and methods include supervised and unsupervised machine learning. In some embodiments, a final prediction of an operating condition is derived using the ensemble of machine learning models, where predictions from multiple machine learning models contribute to the final prediction. A statistical mode (e.g., average) or voting scheme is applied to the multiple predictions from the ensemble of machine learning models to determine a final prediction of operating conditions associated with industrial equipment. In FIGS. 15-18, supervised machine learning models are described. In FIGS. 19 and 20, unsupervised machine learning models are described. In the second layer of predictions, the final predicted operating condition is determined from multiple machine learning models using the bucketized sensor data captured by sensor hubs.

FIG. 15 is a block diagram of a physics-based model 1500 for proactive prediction of operating conditions in industrial equipment. The model 1500 determines a physics-based top feature in conjunction with a machine-learning based classifier. FIG. 15 includes sensor data 1502. In an example, sensor data 1502 is captured during operation of industrial equipment. The sensor data 1502 may be captured by one or more sensors (e.g., sensor 120 of FIG. 1) of a sensor hub (e.g., sensor hub 900 and/or sensor hub 950 of FIGS. 9A and 9B). A low pass filter can be applied to the sensor data for denoising. At block 1504, subsample windows are created from the captured sensor data 1502. In some embodiments, subsample windows include measurements captured at regular time intervals. In some embodiments, subsample windows include measurements captured at irregular time intervals. Generally, the preprocessing as described herein modifies the sensor data so that it can be processed by the feature extraction system at reference number 1506. For example, pre-processing converts the sensor data from a first, raw format to a second format. In some embodiments, the preprocessing can vary according to the particulars of the feature extraction system used.

At reference number 1506, wavelet transforms are shown. A wavelet transform is a mathematical function used to divide a given function or continuous time signal into different scale components. The wavelet transform provides frequency information with the corresponding temporal data. In some embodiments, a wavelet transform decomposes the input into wavelets of various scales in the time domain. The wavelet transform is applied to the sensor data, and the resulting wavelets have variable window sizes and provide a local structure of the data in a time-frequency domain. In an example, sensor hubs capture sensor data that is pre-processed and reshaped into small packets of 100 sub-samples, 60% training, 20% validation, and 20% test. The sensor data is transformed into wavelets. The wavelets may be a 128×128 resolution on scale. Wavelet transforms can be used effectively for transient feature extraction and to extract signal features over an entire spectrum without a dominant frequency band. Using wavelet transforms, frequency information in the sensor data is extracted. Wavelet decomposition coefficients are determined using the sensor data, and the resulting coefficients are represented by one or more feature vectors.

At reference number 1508, principal component analysis (PCA) is shown. The one or more feature vectors determined through the application of wavelet transforms are processed using PCA. PCA reduces the dimensionality of the feature vectors by projecting each data point onto a first few principal components to obtain lower dimensional data while preserving as much of the variation in the feature vectors as possible. In some embodiments, the dimensionality of features extracted using wavelet transform based feature extraction is reduced via principal component analysis to transform the original extracted features into a new set of uncorrelated features. In some embodiments, wavelet patterns produced by the wavelet transforms of sensor data captured during various operating conditions are visually different. These distinct patterns are learned by the model during training.

At reference number 1510, the feature vectors are obtained by a machine learning model. In the example of FIG. 15, a machine learning based classifier predicts one or more operating conditions by classifying the feature vectors into one or more operating conditions. In an example, the machine learning model is a decision-tree-based ensemble machine learning algorithm that uses a gradient boosting framework (e.g., XGBoost). In an example, the machine learning model is a supervised learning algorithm consisting of a number of decision trees that are averaged (e.g., Random Forest). Additionally, in an example, the machine learning model as described herein is linear algorithm based on a cost function defined as a sigmoid function (e.g., logistic regression).

Accordingly, the at least one operating condition is identified by a likelihood the operating condition exists based on the sensor data captured using the sensor hubs. In an example, the machine learning based classifier uses a training dataset to determine how the extracted features relate to one or more operating conditions. The machine learning model according to the present techniques can classify the sensor data captured by sensor hubs into any operating condition. At block 1512, the performance of the machine learning model in predicting the one or more operating conditions is evaluated in a confusion matrix format. In some embodiments, evaluation of the classification in a confusion matrix format enables visualization of the performance of the classifier.

The block diagram of FIG. 15 is not intended to indicate that the model 1500 is to include all of the components shown in FIG. 15. Rather, the model 1500 can include fewer or additional components not illustrated in FIG. 15 (e.g., additional pre-processing, transforms, feature extraction, machine learning models, confusion matrices, etc.) The model 1500 may include any suitable number of additional components not shown, depending on the details of the specific implementation. Furthermore, any of the described systems and techniques can be partially, or entirely, implemented in hardware and/or in a processor. For example, the functionality can be implemented with an application specific integrated circuit, in logic implemented in a processor, in logic implemented in a specialized graphics processing unit, or in any other device.

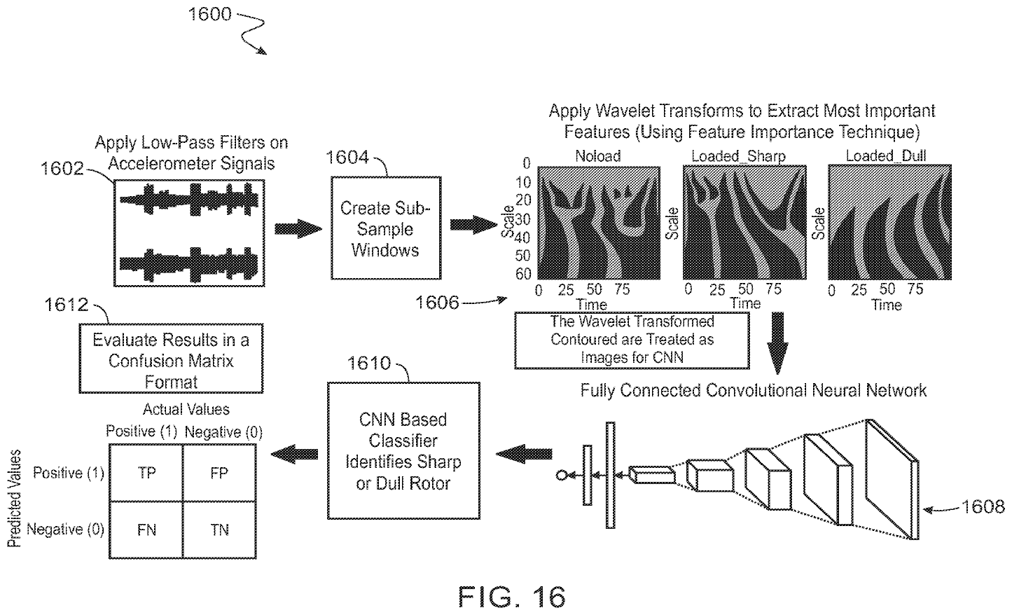

FIG. 16 is a block diagram of a model 1600 for proactive prediction of operating conditions in industrial equipment. The model 1600 is based on wavelet transforms in conjunction with a convolutional neural network. Similar to FIG. 15, FIG. 16 includes sensor data 1602. The sensor data 1602 may be captured by one or more sensors (e.g., sensor 120 of FIG. 1) of a sensor hub (e.g., sensor hub 900 and/or sensor hub 950 of FIGS. 9A and 9B). A low pass filter can be applied to the sensor data for denoising. At block 1604, subsample windows are created from the captured sensor data 1602. In some embodiments, subsample windows include measurements captured at regular time intervals. In some embodiments, subsample windows include measurements captured at irregular time intervals. Additionally, at block 1604 the data may be further preprocessed according to the particular feature extraction system. Generally, the preprocessing as described herein modifies the sensor data so that it can be processed by the corresponding feature extraction system. In some embodiments, the preprocessing can vary according to the particulars of the feature extraction system used.

At reference number 1606, wavelet transforms are illustrated. In the example of FIG. 16, the wavelet transforms are determined using a feature importance technique. In particular, a threshold is applied to the wavelet transform to determine the most important features. As used herein, the most important features are those features that are above a predetermined threshold. In an example, sensor data is captured, a low pass filter is applied, and filtered data is pre-processed. The filtered data is reshaped into small packets of 100 subsamples, including training, validation, and testing packets. The wavelet transforms based on the filtered data is ranked and input to a fully connected convolutional neural network (CNN) at reference number 1608. In some embodiments, the wavelet transforms are processed by the fully connected convolutional neural network as images. At reference number 1608, a CNN is shown. In some embodiments, the CNN is a wavelet-based CNN including several layers, such as convolutional layers, subsampling layers, and fully connected layers. In the example of FIG. 16, wavelets were used as they have very distinct patterns and can be treated as images. The CNN classifies the data output by the feature extraction system into one or more operating conditions.

At reference number 1610, a CNN based classifier identifies an operating condition of the industrial equipment. One or more operating conditions are predicted by classifying the feature vectors into one or more operating conditions. At block 1612, the performance of the machine learning model in predicting the one or more operating conditions is evaluated in a confusion matrix format. In some embodiments, evaluation of the classification in a confusion matrix format enables visualization of the performance of the classifier.

The block diagram of FIG. 16 is not intended to indicate that the model 1600 is to include all of the components shown in FIG. 16. Rather, the model 1600 can include fewer or additional components not illustrated in FIG. 16 (e.g., additional pre-processing, transforms, CNNs, machine learning models, confusion matrices, etc.) The model 1600 may include any suitable number of additional components not shown, depending on the details of the specific implementation. Furthermore, any of the described systems and techniques can be partially, or entirely, implemented in hardware and/or in a processor. For example, the functionality can be implemented with an application specific integrated circuit, in logic implemented in a processor, in logic implemented in a specialized graphics processing unit, or in any other device.

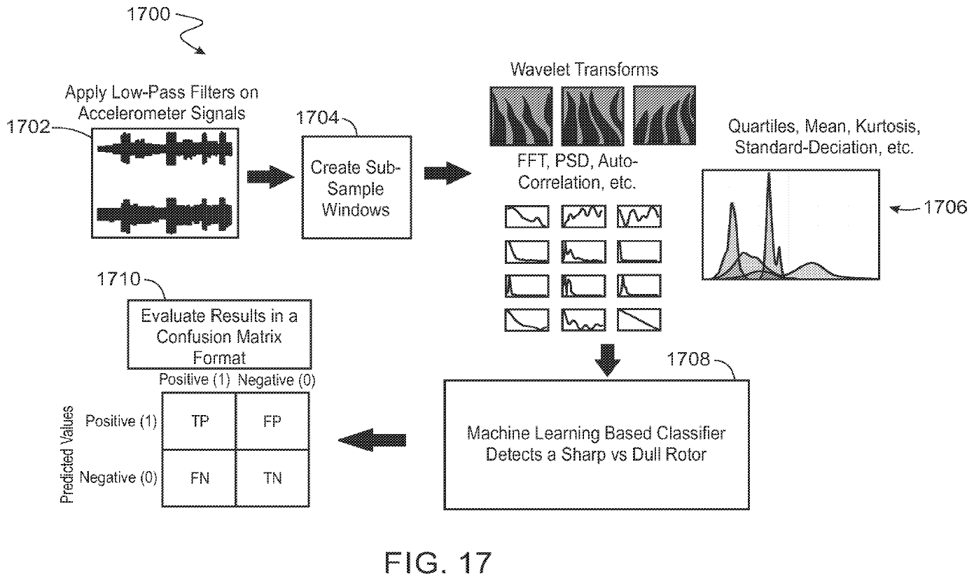

FIG. 17 is a block diagram of a physics-based model 1700 for proactive prediction of operating conditions in industrial equipment. The model 1700 determines a physics-based top feature in conjunction with a machine-learning based classifier. FIG. 17 includes sensor data 1702. In an example, sensor data 1702 is captured during operation of industrial equipment. The sensor data 1702 may be captured by one or more sensors (e.g., sensor 120 of FIG. 1) of a sensor hub (e.g., sensor hub 900 and/or sensor hub 950 of FIGS. 9A and 9B). A low pass filter can be applied to the sensor data for denoising. At block 1704, subsample windows are created from the captured sensor data 1702. In some embodiments, subsample windows include measurements captured at regular time intervals. In some embodiments, subsample windows include measurements captured at irregular time intervals. Additionally, at block 1704 the data may be further preprocessed according to the particular feature extraction system selected at reference number 1706. Generally, the preprocessing as described herein modifies the sensor data so that it can be processed by the corresponding feature extraction system. For example, pre-processing converts the sensor data from a first, raw format to a second format. In some embodiments, the preprocessing can vary according to the particulars of the feature extraction system used.

At reference number 1706, a plurality of feature extraction systems are illustrated. As used herein, a feature extraction system is one or more processes, techniques, or components used to characterize sensor data captured by sensors or sensor hubs. In the example of FIG. 17, feature extraction systems include wavelet transforms, statistical feature extraction (e.g., quartiles, mean, kurtosis, standard deviation, etc.), and time series feature extraction (e.g., fast Fourier transform (FFT), power spectral density (PSD), auto-correlation, etc.). In some embodiments, the feature extraction system outputs a feature vector. In some embodiments, a dimensionality of the output of feature extraction system at reference number 1706 is reduced using PCA. PCA reduces the dimensionality of the output by projecting each data point onto a first few principal components to obtain lower dimensional data while preserving as much of the data's variation as possible. Additionally, in some embodiments, t-distributed stochastic neighbor embedding (t-SNE), Principal Component Analysis and Linear Discriminant Analysis are introduced to reduce the dimensionality of the feature vectors.

In an example, a feature extraction system applied to the sensor data is a frequency domain analysis. Generally, the frequency domain analysis includes a fast Fourier transform (FFT), power spectral density (PSD), auto-correlation, and the like. The FFT translates the sensor data from the time domain into the frequency domain and features are extracted. The power spectral density of the sensor data can also be computed, and features extracted from the power spectral density. Generally, autocorrelation is the correlation of a signal with the delayed copy of itself. Features are extracted from the correlation are input to a machine learning based classifier at reference number 1708. Pre-processing data when the feature extraction system is a frequency domain analysis includes applying a low pass filter to raw accelerometer data to denoise the raw data.

In a frequency domain analysis, features are extracted as peak amplitudes on a chart charting against time lag in seconds. For a subsample window of sensor data, the FFT, power spectral density, and autocorrelation are plotted. The peaks of each algorithm (FFT, power spectral density, and autocorrelation) are distinct and different for each of the conditions. In some embodiments, the machine learning algorithm distinguishes between conditions based on the peak of the respective frequency domain analysis plots. In another example, a feature extraction system applied to the sensor data is a statistical time domain feature extraction system. In this example, statistical time domain features include quartiles, mean, kurtosis, standard deviation, and the like.

In some embodiments, local characteristic decomposition (LCD) is used to transform the raw signals into a number of intrinsic scaled components (ISC). In the subsequent steps, any feature extraction system is applied to the ISC (e.g., FFT, wavelet transformations, kurtosis, mean, median etc.). For each feature extracted using post LCD-ISC (e.g., high dimensional features), dimensional reduction techniques like t-SNE or PCA are implemented. These reduced dimensional features can then be input into a machine learning based classifier for classifying into different pump conditions.

At reference number 1708, the output of the one or more feature extraction systems is obtained by a machine learning model. The machine learning model predicts one or more operating conditions by classifying the data output by the feature extraction system into the one or more operating conditions. In an example, the machine learning model is a decision-tree-based ensemble machine learning algorithm that uses a gradient boosting framework (e.g., XGBoost). In an example, the machine learning model is a supervised learning algorithm consisting of a number of decision trees that are averaged (e.g., Random Forest). Additionally, in an example, the machine learning model as described herein is a linear algorithm based on a cost function defined as a sigmoid function (e.g., logistic regression).

The at least one operating condition is identified by a likelihood the operating condition exists based on the sensor data. In an example, the machine learning based classifier uses a training dataset to determine how the extracted features relate to one or more operating conditions. The machine learning model according to the present techniques can classify data captured by the sensor hubs into any suitable operating condition. At block 1710, the performance of the machine learning model in predicting the one or more operating conditions is evaluated in a confusion matrix format. In some embodiments, evaluation of the classification in a confusion matrix format enables visualization of the performance of the classifier.

The block diagram of FIG. 17 is not intended to indicate that the model 1700 is to include all of the components shown in FIG. 17. Rather, the model 1700 can include fewer or additional components not illustrated in FIG. 17 (e.g., additional pre-processing, frequency domain analysis, time series feature extraction, statistical based feature extraction, machine learning models, confusion matrices, etc.) The model 1700 can include any suitable number of additional components not shown, depending on the details of the specific implementation. Furthermore, any of the described systems and techniques can be partially, or entirely, implemented in hardware and/or in a processor. For example, the functionality can be implemented with an application specific integrated circuit, in logic implemented in a processor, in logic implemented in a specialized graphics processing unit, or in any other device.

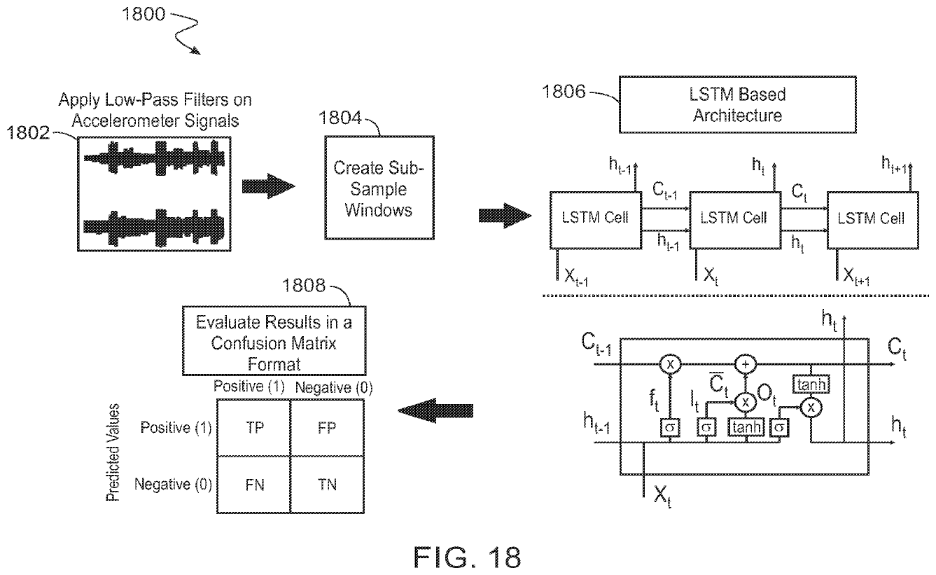

FIG. 18 is a block diagram of a long short-term memory (LSTM) based model 1800 for proactive prediction of operating conditions in industrial equipment. The model 1800 is an LSTM deep learning architecture with auto-extraction classification. Similar to FIG. 16, FIG. 18 includes sensor data 1802. The sensor data 1802 may be captured by one or more sensors (e.g., sensor 120 of FIG. 1) of a sensor hub (e.g., sensor hub 900 and/or sensor hub 950 of FIGS. 9A and 9B). A low pass filter can be applied to the sensor data for denoising. At block 1804, subsample windows are created from the captured sensor data 1802. In some embodiments, subsample windows include measurements captured at regular time intervals. In some embodiments, subsample windows include measurements captured at irregular time intervals. Generally, the preprocessing as described herein modifies the sensor data so that it can be processed by the feature extraction system at reference number 1806. For example, pre-processing converts the sensor data from a first, raw format to a second format. In some embodiments, the preprocessing can vary according to the particulars of the feature extraction system used.

At reference number 1806, an LSTM based architecture is shown. The LSTM processes a plurality of parallel sequences of sensor data. For example, a three axis accelerometer captures data along the x, y, and z axes. Data captured along each axis is referred to as a parallel sequence of sensor data. Using an LSTM based architecture, the raw sensor data is filtered to remove noise. The LSTM then extracts features from the filtered signals and classifies the features into one or more operating conditions. In some embodiments, creating subsample windows of the raw sensor data for input into an LSTM based architecture includes partitioning the data into multiple overlapping windows. In some embodiments, the input data is classified into one or more operating conditions by using the prediction from the last time step as the classification head of the neural network. The LSTM based architecture as described herein implements a gate-based network (e.g., LTSM, Recurrent Neural Network, Gated Recurrent Units, etc.) to classify the sensor data into an operating condition without separate feature extraction for classification.

At block 1808, the performance of the LSTM-based architecture in predicting the one or more operating conditions is evaluated in a confusion matrix format. In some embodiments, evaluation of the classification in a confusion matrix format enables visualization of the performance of the classifier.

The block diagram of FIG. 18 is not intended to indicate that the model 1800 is to include all of the components shown in FIG. 18. Rather, the model 1800 can include fewer or additional components not illustrated in FIG. 18 (e.g., additional pre-processing, LTSM architectures, machine learning models, confusion matrices, etc.) The model 1800 can include any suitable number of additional components not shown, depending on the details of the specific implementation. Furthermore, any of the described systems and techniques can be partially, or entirely, implemented in hardware and/or in a processor. For example, the functionality can be implemented with an application specific integrated circuit, in logic implemented in a processor, in logic implemented in a specialized graphics processing unit, or in any other device.

In unsupervised machine learning models, sensor data distributions in terms of width of degree of variance/standard-deviation are determined. A numerical threshold is devised to predict operating conditions of the industrial equipment. In examples, thresholds can be defined to categorize or identify different operating conditions.

FIG. 19 shows a density plot 1900. In the example of FIG. 19, a distribution of sensor data is illustrated. The distribution of sensor data refers to the shape of the graph 1900 when the sensor data is plotted based on how frequently each data point occurs. The mean acceleration components are represented along an x-axis 1902 representing data values and a y-axis 1904 representing the number of occurrences of the data point in the sensor data. Distributions 1910, 1912, 1914, and 1916 are illustrated. In examples, the distribution 1910 represents data points that correspond to an anomalous condition, such as operation using a blunt cutter of a cutting machine. The distribution 1912 represents data points that correspond to a normal condition, and the distribution 1914 represents data points that correspond a no load condition. In the example of a cutting machine, a no load condition signifies that the cutters are not fully engaged to shear samples. The distribution 1916 represents data points that correspond to a transition into an anomalous condition. In the example of a cutting machine, the distribution 1916 represents a transition to a blunt state of a cutter. In addition, based on the confidence-interval/probability scores generated from deep learning or machine learning-based classifier-models, a numerical measure can be devised to pro-actively alert the operators (in terms of traffic light). In examples, sigmoid or SoftMax-based functions which generate probability scores to classify input data into a specific category. For example, in a binary classification, higher the confidence in a predicted class of operating conditions, the closer the probability score is to one. The lower the confidences is in a predicted class of operating conditions, the closer the probability score is to zero. Based on the distribution of probability scores, an appropriate threshold can be selected to pro-actively predict operating conditions of the industrial equipment. In turn, the predictions can be used to alert operators to the operating conditions of the industrial equipment.

FIG. 20 is a block diagram of an LSTM-auto encoder-based model 2000 for proactive prediction of operating conditions in industrial equipment. FIG. 20 includes sensor data 2002. In an example, sensor data 2002 is captured during operation of industrial equipment. The sensor data 2002 may be captured by one or more sensors (e.g., sensor 120 of FIG. 1) of a sensor hub (e.g., sensor hub 900 and/or sensor hub 950 of FIGS. 9A and 9B). In examples, the sensor data 2002 is accelerometer data captured along the x-y-z axes in a three-dimensional coordinate system.

At reference number 2004, an LSTM-auto encoder is illustrated. In embodiments, the LSTM-auto encoder is an encoder that makes use of the LSTM encoder-decoder architecture to compress sensor data using an encoder and decode it to retain original structure using a decoder. The LTSM auto-encoder enables detection of temporal patterns in the sensor data that correspond to various operating conditions. For ease of description, an LSTM-auto encoder has been described. However, any similar auto-encoder can be used.

At reference number 2006, model loss is determined. The model loss represents the evolution of mean-average error or mean-squared error (MAE/MSE) loss functions with multiple iterations/epochs executed on training and validation datasets. At reference number 2006, the loss function saturates after 20-30 epochs, indicating that the model weights are optimized.

At reference number 2008, thresholds are applied to the sensor data to predict operating conditions of industrial equipment. A threshold based approach can be used to detect anomalous conditions or outliers. In the example of a cutting machine, the anomalous condition can be a degree of bluntness of the cutter. The distributions of loss functions are plotted with frequency of occurrences on vertical axis and each individual loss-values plotted along the horizontal axis. As shown at reference number 2008, the distribution consists of values less than 0.1. Based on that, appropriate thresholds are determined for detecting anomalies in any future vibration signals. For example, if the magnitude of loss function exceeds the thresholds, anomalies are detected.

The machine learning models can be deployed at an operational site in one or more configurations. In a first configuration, supervised machine learning models are deployed. Historical labeled data for various operating conditions of the industrial equipment under the most frequent operating configurations in production is obtained. The models can be trained using this data on edge devices, or the models are trained in the cloud and deployed as needed. In the example of a cutting machine, the operator of the cutting machine can provide historical labeled data for both a sharp operating condition and a dull operating condition. In examples, a sharp operating condition is a nominal operating condition, while a dull operating condition is an anomalous operating condition.

In a second configuration, supervised machine learning models are deployed, and rigorous labeled data collection trials are performed for various operating conditions under the most frequent operating configurations in production for the industrial equipment. Again, models can be trained using this data on edge devices, or the models are trained in the cloud and deployed as needed. In the example of a cutting machine, the results of the data collection trials with labeled data for sharp operating conditions and dull operating conditions are obtained.

In a third configuration, unsupervised machine learning models are deployed. Historical data associated with a nominal operating condition of the industrial equipment is provided. However, no labeled data is provided for anomalous conditions and the model attempts to detect any drift from the baseline nominal operating conditions of the industrial equipment. In the example of a cutting machine, the trained machine learning model detects drift from a baseline sharp configuration. If there is a drift due to a new configuration (as confirmed by the operator), the data goes into re-training process post a confirmation by the operator that the drift is due to a known cause. The cause is then noted for additional model capabilities (e.g. misalignment or wear/tear, etc.) using active training to continuously update the model. Otherwise, the model continues to detect anomalous conditions in the form of drifts. The unsupervised machine learning models can be trained using this data on edge devices, or the models can be trained in the cloud and deployed as needed. In active training, the machine learning model is trained using unlabeled input data by identifying patterns in the unlabeled input data and predicting the operating conditions based on, at least in part, the identified patterns.

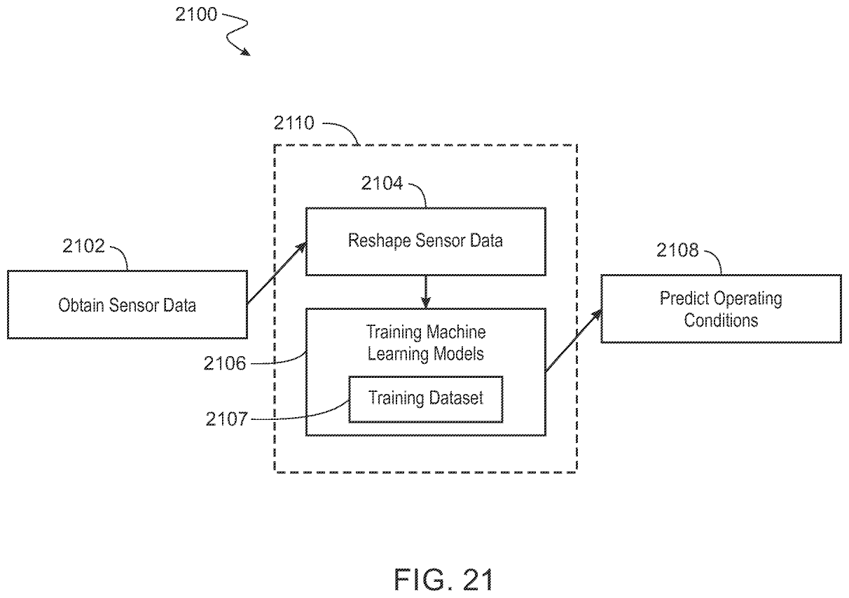

FIG. 21 is a process flow diagram of a process 2100 that enables proactive prediction of operating conditions in industrial equipment. The process 2100 is operable using the sensor hub 900 of FIG. 9A including the sensor 120 of FIG. 1A, sensor hub 950 of FIG. 9B including the sensor 120 of FIG. 1A, the data flow architecture 1000 of FIG. 10, the network 1100A of FIG. 11A, the system 1300 of FIG. 13, the pipeline 1400 of FIG. 14, and the machine learning models in FIGS. 15-18 and 20.

At block 2102, sensor data is obtained. Sensor hubs are configured to capture sensor data associated with one or more operating conditions of the industrial equipment. In embodiments, the sensor data is processed prior prediction. At block 2104, the sensor data captured from sensor hubs is reshaped into buckets, with subsample windows of a predetermined size.

Within dashed box 2110, a two-layer approach for proactive prediction of operating conditions is provided. A first layer re-shapes the sensor data so that predictions are made for a number of sub-sample windows. A second layer uses an ensemble-based model comprising multiple trained machine learning models to generate the predictions for the sub-sample windows. Accordingly, at block 2104, the sensor data is re-shaped. At block 2106, sensor data is input to a trained machine learning model, wherein the trained machine learning model comprises a physics based feature extraction model and a deep learning based automatic feature extraction model. In examples, an ensemble based model is trained using features extracted from classical physics based feature-extraction techniques like wavelet transforms, FFT, PSD, etc. in conjunction with deep-learning based auto-features. At block 2108, anomalous conditions associated with operation of the industrial equipment are predicted.

In some embodiments, a training dataset is captured by the sensor hubs and used to train the machine learning models. For example, the training dataset at block 2107 includes additional sensor data such as data from IMUs or temperature data. A training dataset can also include metadata. In examples, metadata includes a location of the industrial equipment, a number of active parameters associated with the industrial equipment, or any combinations thereof. The training dataset from the sensor hubs is captured at two or more time intervals. In examples, the time intervals correspond to a number of days. By collecting data over a number of days, overfitting of the trained machine learning model is avoided. In examples, the two or more time intervals include at least a first time interval and a second time interval, the first time interval spanning a first amount of time during a given day, and the second time interval spanning a second amount of time during the given day, the second amount of time being shorter than the first amount of time and being separated from the first amount of time during the given day. The training dataset is labeled as corresponding to at least one operating condition, and a machine learning model is trained using a training dataset comprising the labeled additional sensor data. In some embodiments, the training dataset includes additional sensor data, additional temperature data, infrared heat maps of the product being produced, and images of an output material or finished product of the industrial machine. The machine learning model can be trained using any combination of the additional sensor data, additional temperature data, infrared heat maps of the product being produced by the industrial machine, and images of the product being produced by the industrial machine.

The process flow diagram of FIG. 21 is not intended to indicate that the blocks of the example process 2100 are to be executed in any order, or that all of the blocks are to be included in every case. Further, any suitable number of additional blocks not shown may be included within the example process 2100, depending on the details of the specific implementation.

Although exemplary processing systems have been described, implementations of the subject matter and the functional operations described above can be implemented in other types of digital electronic circuitry, or in computer software, firmware, or hardware, including the structures disclosed in this specification and their structural equivalents, or in combinations of one or more of them. Implementations of the subject matter described in this specification, such as control of a data generation, model training, and model execution can be implemented as one or more computer program products, i.e., one or more modules of computer program instructions encoded on a tangible program carrier, for example a computer-readable medium, for execution by, or to control the operation of, a processing system. The computer readable medium can be a machine readable storage device, a machine readable storage substrate, a memory device, or a combination of one or more of them.

The term “system” may encompass all apparatus, devices, and machines for processing data, including by way of example a programmable processor, a computer, or multiple processors or computers. A processing system can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, executable logic, or code) can be written in any form of programming language, including compiled or interpreted languages, or declarative or procedural languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Computer readable media suitable for storing computer program instructions and data include all forms of non-volatile or volatile memory, media and memory devices, including by way of example semiconductor memory devices, e.g., EPROM, EEPROM, and flash memory devices; magnetic disks, e.g., internal hard disks or removable disks or magnetic tapes; magneto optical disks; and CD-ROM, DVD-ROM, and Blu-Ray disks. The processor and the memory can be supplemented by, or incorporated in, special purpose logic circuitry. Sometimes a server is a general purpose computer, and sometimes it is a custom-tailored special purpose electronic device, and sometimes it is a combination of these things. Implementations can include a back end component, e.g., a data server, or a middleware component, e.g., an application server, or a front end component, e.g., a client computer having a graphical user interface or a Web browser through which a user can interact with an implementation of the subject matter described is this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

A number of embodiments of the invention have been described. Nevertheless, it will be understood that various modifications may be made without departing from the spirit and scope of the invention.

In the foregoing description, embodiments of the invention have been described with reference to numerous specific details that may vary from implementation to implementation. The description and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction. Any definitions expressly set forth herein for terms contained in such claims shall govern the meaning of such terms as used in the claims. In addition, when we use the term “further comprising,” in the foregoing description or following claims, what follows this phrase can be an additional step or entity, or a sub-step/sub-entity of a previously-recited step or entity.

1-29. (canceled)

30. A method, comprising:
obtaining, with at least one processor, sensor data associated with operation of industrial equipment;
inputting, with the at least one processor, the sensor data to a trained machine learning model, wherein the trained machine learning model comprises a physics based feature extraction model and a deep learning based automatic feature extraction model; and
predicting, with the at least one processor, operating conditions associated with operation of the industrial equipment using the trained machine learning models.

31. The method of claim 30, wherein the physics based feature extraction model is built using supervised learning with labeled data comprising labels that correspond to the operating conditions, the labeled data comprising of sensor data from a sensor hub.

32. The method of claim 30, comprising:
re-shaping the sensor data into intermediate buckets to form bucketed data;
dividing the bucketed data into sub-sample windows;
extracting features from the sub-sampled windows; and
predicting the operating conditions for each respective sub-sample window according to the extracted features, wherein an operating condition associated with the intermediate buckets is determined according to a number of predictions associated with the sub-sample windows.

33. The method of claim 30, wherein the deep learning based automatic feature extraction model is trained using unsupervised learning with thresholds calculated from signal distributions in additional sensor data, wherein the thresholds are associated with the operating conditions.

34. The method of claim 30, wherein the deep learning based automatic feature extraction model is trained using unsupervised learning with labeled data comprising labels that correspond to a normal operating condition, the labeled data comprising additional sensor data and additional temperature data.

35. The method of claim 30, comprising detecting a drift from a normal operating condition, wherein the trained machine learning model is actively trained in response to determining a cause of the drift is a modified configuration of the industrial equipment, wherein active training uses the determined cause of the drift.

36. The method of claim 30, wherein the trained machine learning model is actively trained based on unlabeled input data by identifying patterns in the unlabeled input data, and predicting the operating conditions is based on, at least in part, the identified patterns.

37. The method of claim 30, comprising:
obtaining additional sensor data, additional temperature data, operational parameters, or a combination thereof from sensor hubs at two or more time intervals, wherein the additional sensor data is associated with the industrial equipment, and wherein the two or more time intervals include at least a first time interval and a second time interval, the first time interval spanning a first amount of time during a given day, and the second time interval spanning a second amount of time during the given day, the second amount of time being shorter than the first amount of time and being separated from the first amount of time during the given day;
labeling the additional sensor data, the additional temperature data, and the operational parameters as corresponding to at least one operating condition, and
training the machine learning model using a training dataset comprising the labeled additional sensor data, the labeled additional temperature data, and the labeled operating parameters.

38. The method of claim 30, comprising training the machine learning model using additional sensor data, additional temperature data, infrared heat maps of a product being produced by the industrial equipment, images of the product being produced by the industrial equipment, or any combinations thereof.

39. A system, comprising:
at least one processor, and
at least one non-transitory storage media storing instructions that, when executed by the at least one processor, cause the at least one processor to:
obtain sensor data associated with operation of industrial equipment;
input the sensor data to a trained machine learning model, wherein the trained machine learning model comprises a physics based feature extraction model and a deep learning based automatic feature extraction model; and
predict operating conditions associated with operation of the industrial equipment using the trained machine learning models.

40. The system of claim 39, wherein the physics based feature extraction model is built using supervised learning with labeled data comprising labels that correspond to the operating conditions, the labeled data comprising of sensor data from a sensor hub.

41. The system of claim 39, comprising instructions that cause the at least one processor to:
re-shape the sensor data into intermediate buckets to form bucketed data;
divide the bucketed data into sub-sample windows;
extract features from the sub-sampled windows; and
predict the operating conditions for each respective sub-sample window according to the extracted features, wherein an operating condition associated with the intermediate buckets is determined according to a number of predictions associated with the sub-sample windows.

42. The system of claim 39, wherein the deep learning based automatic feature extraction model is trained using unsupervised learning with thresholds calculated from signal distributions in additional sensor data, wherein the thresholds are associated with the operating conditions.

43. The system of claim 39, wherein the deep learning based automatic feature extraction model is trained using unsupervised learning with labeled data comprising labels that correspond to a normal operating condition, the labeled data comprising additional sensor data and additional temperature data.

44. The system of claim 39, comprising instructions that cause the at least one processor to detect a drift from a normal operating condition, wherein the trained machine learning model is actively trained in response to determining a cause of the drift is a modified configuration of the industrial equipment, wherein active training uses the determined cause of the drift.

45. At least one non-transitory storage media storing instructions that, when executed by at least one processor, cause the at least one processor to:
obtain sensor data associated with operation of industrial equipment;
input the sensor data to a trained machine learning model, wherein the trained machine learning model comprises a physics based feature extraction model and a deep learning based automatic feature extraction model; and
predict operating conditions associated with operation of the industrial equipment using the trained machine learning models.

46. The at least one non-transitory storage media of claim 45, wherein the physics based feature extraction model is built using supervised learning with labeled data comprising labels that correspond to the operating conditions, the labeled data comprising of sensor data from a sensor hub.

47. The at least one non-transitory storage media of claim 45, comprising instructions that cause the at least one processor to:
re-shape the sensor data into intermediate buckets to form bucketed data;
divide the bucketed data into sub-sample windows;
extract features from the sub-sampled windows; and
predict the operating conditions for each respective sub-sample window according to the extracted features, wherein an operating condition associated with the intermediate buckets is determined according to a number of predictions associated with the sub-sample windows.

48. The at least one non-transitory storage media of claim 45, wherein the deep learning based automatic feature extraction model is trained using unsupervised learning with thresholds calculated from signal distributions in additional sensor data, wherein the thresholds are associated with the operating conditions.

49. The at least one non-transitory storage media of claim 45, wherein the deep learning based automatic feature extraction model is trained using unsupervised learning with labeled data comprising labels that correspond to a normal operating condition, the labeled data comprising additional sensor data and additional temperature data.
